(19) United States
(12) Patent Application Publication
(10) Pub. No.: US 2010/0129259 A1
(43) Pub. Date: May 27, 2010

(54) High throughput sample preparation

(75) Inventor: Norman Binz DeWalch, Houston, TX (US)

Correspondence Address: DEWALCH TECHNOLOGIES, INC., 6850 WYNNWOOD LANE, HOUSTON, TX, 77008, US

(73) Assignee: DeWalch Technologies, Inc.

(21) Appl. No.: 12/455,575

(22) Filed: Jun. 2, 2009

Related U.S. Application Data
(63) Continuation of application No. 10/677,918, filed on Oct. 2, 2003, now abandoned.

(51) Int. Cl. G01N 35/02; G01N 35/04; G01N 35/10

(52) U.S. Cl. 422/65; 422/63

(57) ABSTRACT

Methods, devices, and systems are provided for processing and manipulation of biological substances. A variety of example embodiments are shown in which enhanced processing are provided. In one non-limiting example, a device is provided for processing containers having a plurality of biological sample wells wherein at least one of the wells includes a biological sample. The device comprises processing stations, a sample guide between the at least two processing stations, and an actuator of the container from at least one processing station to at least another processing station.

### BACKGROUND OF THE INVENTION

Recent research initiatives have spawned an increased effort to streamline the various processes used to perform Life Sciences research. The complexity of biological organisms has necessitated the development of a range of laboratory procedures to manipulate biological materials. There is a particular need to isolate various substances such as nucleic acids, proteins, cellular metabolites, carbohydrates and lipids from such biological materials in order to perform the analytical processes used to define and interpret living systems. At the same time, technological advancements have begun to make it possible to analyze biological organisms in a more comprehensive, holistic manner. High throughput analytical technologies have led to advancements in genomics, proteomics, metabolomics and systems biology. Nevertheless, while there has been substantial advancement in developing efficient high throughput analytical processes, the fundamental requirement to prepare biological and biochemical substances for analysis remains a rate limiting step to full implementation of these analytical methods.

There are various methods for preparing biological and biochemical substances and these methods generally include a series of steps in which a substance of interest is processed, for example, by sequentially collecting material, such as by adsorption, sedimentation, centrifugation or filtration; modifying the starting substance, such as by treatment with chaotropic agents, or lysing cellular materials; separating a selected sub-fraction of the material collected, for example, by performing gel chromatography, filtration, or selective adsorption to a binding matrix; further separating sub-fractions, such as by washing with liquids like appropriate wash buffers, or by selective elution of sub-fractions from a gel or binding matrix, and releasing, eluting or collecting the processed material to yield a desired substance, for example, a substantially purified nucleic acid, protein, carbohydrate, or lipid molecule. Historically, all of these methods have necessarily required multiple transfers of the material being processed from one container to others, in series as the processing procedure is carried out.

Specific substances that must be prepared from biological materials to analyze biological organisms include: single and double stranded DNA molecules from bacteriophages; bacterial plasmids; fungal plasmids such as yeast plasmids; Bacterial Artificial Chromosomes (BAC's); viral nucleic acids, genomic DNA from a variety of cell types such as genomic DNA from nucleated blood cells; protein molecules; antibody molecules; RNA molecules; carbohydrate molecules; lipid molecules; and cell metabolites.

In addition, it is also important to be able to process biochemical samples generated by in vitro manipulations of various macromolecules in order to conduct further biochemical manipulation or analysis. Examples of such processes include: nucleic acid template preparation for biochemical manipulations such as PCR or DNA sequencing; the clean-up of biochemical reaction products, such as DNA thermocycle sequencing products; the clean-up of PCR reaction products for further manipulation and/or analysis; the preparation of biochemically modified or processed protein molecules for further modification or analysis, such as preparation of protein fragments for analysis by MALDI-TOF mass spectrometry; and the preparation of labeled nucleic acid samples, such as cDNA labeled with fluorescent dyes for expression analysis with gene chips or spotted arrays.

Thus, there is a need for broadly applicable technology that can be easily adapted to perform a variety of sample processing procedures that share common process elements.

A specific case where there is a need to improve the efficiency of sample preparation processes is in the preparation of DNA template molecules for analysis by DNA sequencing. Standard methods for purifying plasmid templates for sequencing have been developed by incremental modification of a few traditional procedures that necessarily require a significant number of steps and the transfer of liquid samples from container to container. For example, current protocols for purifying nucleic acid samples for sequencing include an initial centrifugation step, which is used to collect and concentrate cultured bacterial cells that contain cloned DNA molecules so that the cloned molecules can be purified. Because this step must be accomplished without the loss of the sample, the centrifugation must be performed in a sample container that is completely sealed at the bottom.

Many of these protocols also include a filtration step, wherein the sample substance containing the nucleic acid and waste products is passed through a filtering means. The filter material selectively binds to the target nucleic acid, while allowing the liquid and waste products to flow through. Because it is necessary to remove the waste products and liquid after filtration, this step must be performed in a sample container which already includes an opening below the filtering means. Examples of such containers are shown in U.S. Pat. No. 4,683,058 (1987, Lyman et al.), U.S. Pat. No. 5,264,184 (1993, Aysta et al.), and U.S. Pat. No. 5,910,246 (1999, Walter et al.); the teachings of which are incorporated by reference.

Since the container requirements for these two steps are incompatible, the sample must be transferred from the closed container (used for centrifugation) to the container which includes the opening (used for the filtration step), which adds a step to the overall process. Furthermore, the closed containers (usually plastic test tubes) are discarded after the transfer. If the same container or test tube could be used for both the centrifugation and filtration steps, the time consuming transfer step could be eliminated, and the amount of solid waste generated could be reduced. Therefore, there is a long felt need for a method and apparatus for processing substances in a single container.

The sequencing of DNA has long been relegated to the controlled environment of the research laboratory. In order to ensure high quality data, current laboratory protocols implement many precise, manual operations which could only be performed by skilled technicians. Although numerous mechanical devices exist to perform some of these individual operations, the overall number of operations remains large, and each of these devices still requires skilled supervision. Furthermore, each additional step in the process is a potential source of error. A particularly time consuming part of the sequencing process is the isolation and purification of DNA templates from the bacterial cultures in which the DNA is cloned. Many existing methods for DNA template preparation have been adapted to the standard 96-well format, in which samples are batch processed in trays or plates, each containing 96 tubes or sample wells. One such method is disclosed in Anderson et al., Method for 96-well M13 DNA Template Preparations for Large-Scale Sequencing, BioTechniques (June 1996). Another example of such a method is disclosed in QIAprep 96 M13 Protocol, QIAprep M13 Handbook (2/99) from Qiagen Incorporated. These references are herein incorporated by reference.

Recent research initiatives have created great demand for large-scale, high-speed techniques for sequencing and mapping genetic material. Although several integrated machines have been developed which automate some or all of the template preparation process, these machines usually duplicate the manual operations of the previous methods without seeking to eliminate or consolidate steps. Furthermore, many of these methods require the use of expensive and highly specialized sample containers, which essentially have no other uses except as disclosed. Methods of this type are disclosed in U.S. Pat. No. 5,610,074 (Beritashvili et al., 1997) and U.S. Pat. No. 5,863,801 (Southgate et al., 1999), incorporated herein by reference. Thus, there is long felt need for a method or apparatus for processing substances in a single container.

An example of at least one such method and apparatus is seen in U.S. patent application Ser. No. 10/641,378 (filed Oct. 13, 2003, claiming priority to commonly-assigned U.S. patent application Ser. No. 09\658,017, which was filed Sep. 12, 2000, which was, in turn, a continuation-in-part of U.S. application Ser. No. 09/532,599, filed Mar. 22, 2000, and also commonly-assigned). Each of the preceding commonly-assigned applications is incorporated herein by reference.

Polynucleotides come in many forms and a number of alternative forms have been manipulated by recombinant DNA techniques to develop the common tools used to perform contemporary molecular biology research. For example, a “plasmid” is an extrachromosomal, autonomously replicating DNA molecule (also a polynucleotide) commonly employed in genetic research to carry out various manipulations of DNA polynucleotides. In a common use, DNA fragments cloned into plasmid molecules are used as a template for “DNA sequencing” to determine the exact series of bases (A, C, G or T mononucleotides) in a particular DNA fragment. The plasmid is replicated by host cells (e.g., bacterial cells). A virus, like a plasmid, is a polynucleotide molecule, but it can also infect host cells. The term “phage” is used to describe a group of bacterial viruses (“phage” means “eater” because these viruses were first observed as blank areas on carpets of bacterial cells where these holes in the bacterial growth appeared to have been eaten), and a “vector” is an engineered form of a polynucleotide capable of carrying another polynucleotide insert. “Cosmids,” are modified replicons that contain viral sequences derived from bacteriophage lambda that direct DNA replication but do not contain many viral structural genes such as coat proteins. Cosmids are engineered to carry relatively large polynucleotides inserts, 20-40 kb in length, and can be packaged in vitro into a viral coat protein. They can infect a cell and be propagated in vivo. “Phosmids,” are like cosmids, and contain sequences derived form both phagemid and cosmid vectors, thus combining functional properties of both of these systems. There are additional forms of polynucleotides (e.g., BACs or bacterial artificial chromosomes, PAC's, YAC's and others, each designed to perform alternative useful genetic manipulations).

A plasmid is an epigenetic element; it is not part of the host chromosomal DNA molecule. A large number of naturally occurring plasmid molecules have been isolated and analyzed, and a number of them have been modified to produce useful vectors for genetic manipulations including, but not limited to: cloning individual genes; facilitation of manipulation of polynucleotide sequences such as site specific mutagenesis; expression of recombinant proteins; and amplification of appropriate amounts of desired polynucleotide molecules for probes or genetic analysis. Others will occur to those of skill in the art.

Historically, plasmids were discovered in cells, and it was found that they could be separated from the cell, and engineered for a variety of purposes. When handled appropriately, plasmid DNA's are quite stable under typical laboratory conditions, so they can be prepared and stored easily and kept available for experimentation as needed. Furthermore, isolated plasmids can be re-introduced into alternative host cells by the process of transformation. Transformed bacteria are commonly used to prepare quantities of plasmid DNA for biochemical manipulation. This is accomplished by growing suitable volumes of plasmid containing bacteria in culture and then performing a plasmid purification process to isolate purified plasmid DNA

In traditional methods of preparation of cloned polynucleotides such as DNA fragments inserted into plasmid vectors, the first step used to isolate clones containing a single specific DNA insert is to spread a diluted mixture of a population of transformed bacteria onto an agar culture media in a petri plate. Bacteria are spread on the agar medium in numbers such that each individual cell will give rise to a distinct, isolated colony of identical cells that can be readily identified and subcultured to prepare a sufficient quantity of plasmid material. In some such processes, a toothpick is contacted with a colony of bacteria that have been grown in a petri dish in which there are multiple colonies of bacteria (each having a particular plasmid associated with the colony). The toothpick is then dropped in a well in a growth vessel or “plate” with appropriate growth media in it. For handling large numbers of transformed colonies, automated devices have been developed that locate the colonies on a plate and use robotic techniques to pick and inoculate cultures. When growing larger quantities of clones, it is common to inoculate isolated colonies into standard 96 well microtiter plates or alternatively 96 well culture blocks which can hold more than 1 mL of liquid culture medium. In existing methods, the container used for cell culture is used exclusively for that purpose and subsequent sample processing necessarily requires transfer of the cellular material to an alternative container.

The growth media in the wells of the plate is used to grow more of the particular bacteria with the particular plasmid of interest. Typical growth media include: 2xYT, TB (Terrific Broth), and LB (Luria-Bertani); others will occur to those of skill in the art. Typically, the bacteria are allowed to grow for about 12 to about 24 hours.

After the growth in the plate, the bacteria are harvested. That involves, typically, centrifugation (e.g., for 5 minutes). Centrifugation causes the bacteria, which are heavier than the growth media, to sediment to the bottom of the centrifuge tube. The growth media, which is generally liquid, is then poured or pipetted out of the wells of the plate.

A liquid (so-called “buffer”) is then added to the wells, and the wells are agitated to re-suspend the cells. A common method used to purify plasmid DNA molecules is the alkaline lysis method. In this procedure cells are initially resuspended in a Tris-HCl buffered saline solution. They are then lysed, or ruptured by adding an alkaline (typically NaOH) solution to cause the bacteria to break open, in order to free the plasmid from the bacteria. Then a third solution, a neutralization solution, for example a sodium or potassium acetate solution, is added to the lysed cells to neutralize the alkali.

This is a key step that also causes precipitation of unwanted cell components, in particular chromosomal DNA and proteins. A centrifugation step then occurs to further separate the unwanted material. The supernatant that results from the centrifuge includes desired plasmids. The precipitate does not. So the supernatant is drawn off by pipetting or some other means. Plasmid DNA can be further purified and concentrated from this neutralized solution, for example by phenol chloroform extraction and ethanol precipitation, or alternatively by adsorption of the plasmid DNA to a DNA binding substrate such as a silica resin. Plasmid adhered to silica resin is generally processed by sequential washing, drying and elution steps.

In addition to the problems previously discussed regarding the need for a single-container method and apparatus, generally, the preparation of polynucleotides (e.g. plasmids) has suffered from inefficiently-designed process steps, unsophisticated combinations of substances, and the use of various devices that have not lent themselves to efficient processing. This is particularly an issue when it is necessary to prepare larger and larger numbers of plasmid templates for high throughput genomic analysis. There is a long-felt need, therefore, for an apparatus that allows for multi-step processing in a reduced number of reaction chambers, automated handling of the reaction chambers, and for processes and systems that run in a more simplified and automated manner.

### SUMMARY OF THE INVENTION

Various example embodiments of the invention address at least one of the needs described above, as well as other needs that those of skill in the art will recognize, although each example of the invention does not necessarily address all of the needs described above. Each of the examples has its own object(s); they will be apparent to those of skill in the art.

In at least one example of the invention, a device is provided for processing containers having a plurality of biological sample wells wherein at least one of the wells includes a biological sample. The device comprises processing stations, a sample guide between the at least two processing stations, and an actuator of the container from at least one processing station to at least another processing station. Various examples of processing stations include but are not limited to, a processing “plate” dispenser (as sometimes used in the art, “plate” generally refers to containers having multiple sample vessels or wells), a processing plate agitator, and a processing fluid dispenser. In at least one example, the processing fluid dispenser comprises a set of injectors. In at least one more specific example, the injectors are recessed. In a further example, they are stationary. In still a further example, the processing fluid dispenser comprises: at least one reservoir comprising; a biological substance process input port and a plurality of dispense ports; and a set of dispensing protrusions connected to the dispense ports. In some examples, the plurality of dispense ports is arranged in a substantially two-dimensional array. In some further examples, the reservoir comprises a cross-section that tapers from the input port, which allows air in the supply or from the dispense needles to gather above the fluid to be dispensed (which is vented through a valve or other means for removal of air or reduction of pressure in some further examples).

In at least one example of the invention, dispensing protrusions are recessed in a guard member (for example, a set of elongated recesses from the dispensing protrusions).

In still a further example of the invention, at least one of the processing stations comprises a processing plate piercer, and in still a further example, at least one of the processing stations comprises a pressure aperture and a seal positioned and arranged for interaction with the container.

In still another example, at least one of the processing stations comprises a collector plate dispenser and/or a collector plate sealer.

In even further embodiments, the at least two processing stations comprise at least two multi-sample, biological sample container processing stations, guides between the at least two multi-sample, biological sample container processing stations, and/or stops at a plurality of the at least two multi-sample, biological sample container processing stations.

In some such examples, a slideable actuator is mounted between the at least two processing stations.

In still another aspect of the invention, a system is provided for treatment of a plurality of biological samples in a multi-sample container, the system comprising: means for moving a first multi-sample container to a first processing station; means for processing the first multi-sample container at the first processing station; means for moving the first multi-sample container to a second processing station; means for moving a second multi-sample container to the first processing station; means for processing the first multi-sample container at the second processing station; and means for processing the second multi-sample container at the first processing station.

In at least one such system, the means for moving the first multi-sample container is operated during at least a portion of the moving the second multi-sample container. In a further example, the means for processing the first multi-sample container at the second processing station occurs during at least a portion of the processing of the second multi-sample container at the second processing station. In still a further example, the means for processing the first multi-sample container at the first processing station comprises means for contacting a processing fluid with the biological samples in the first multi-sample container (e.g., means for injecting the processing fluid into the first multi-sample container and/or means for maintaining a substantially laminar stream). In at least one specific example, the means for injecting comprises means for isolating injectors from the sample container (e.g., the means for isolating comprises means for recessing injectors in a dispensing head and/or means for controlling relative amounts of processing fluid dispensed into each of the biological samples). In at least one more specific example, the means for controlling comprises means for supplying processing fluid to multiple injection conduits from a proximate reservoir and a supply conduit. In some even more specific examples, the means for supplying processing fluid to the proximate reservoir comprises a pinch actuator on a supply conduit and/or a peristaltic actuator on a supply conduit.

In still another example of the invention, the means for processing the first multi-sample container at the first processing station comprises means for agitating the first multi-sample container (e.g., a “vortexer” as is commonly known).

In at least one example, the first processing station comprises means for creating an aperture for at least one sample in the first multi-sample container, or for example, for each sample in the multi-sample container (e.g., a piercer, using an elongate member.

In still a further example, the means for processing comprises means for removing of a fluid through the aperture (e.g., drawing or pushing air from the aperture with a positive or negative pressure pump).

In some examples of the invention, the means for moving comprises means for pushing the multi-sample container (e.g., a linearly-actuated member comprising a multi-sample container contact member, wherein the contact member is positioned and arranged for pushing the multi-sample container).

In at least one example, the means for moving comprises means for sliding (e.g., a track having means for guiding the multi-sample container from the first processing station to the second processing station and/or stops for positioning the multi-sample container at the first processing station and at the second processing station.

In some examples, at least one processing location comprises a means for sealing the multi-sample container at a given processing location.

In another example, a system is provided as noted above wherein at least one of the processing locations comprises a pressure change aperture and at least one of the processing locations comprises an agitator or shaker (e.g., the vortexer mentioned before). Some further examples include a collection container dispenser. positioned and arranged to place a collection container under the processing plate. In some such examples, the collection container dispenser further comprises a pressure change aperture with a seal for the collection container.

Still further examples of the invention include at least one processing station comprising a processing plate dispenser.

In still another aspect of the invention, a method is provided for treatment of a plurality of biological samples in multi-sample container, the method comprising: moving a first multi-sample container to a first processing station; processing the first multi-sample container at the first processing station; moving the first multi-sample container to a second processing station; moving a second multi-sample container to the first processing station; processing the first multi-sample container at the second processing station; and processing the second multi-sample container at the first processing station.

In at least one example, the moving the first container occurs during at least a portion of the moving of the second container. In a further example, the moving the first multi-sample container occurs during at least a portion of said moving the second multi-sample container. In yet another example, the processing the first multi-sample container at the second processing stations occurs during at least a portion of said processing of the second multi-sample container at the second processing station. In even further examples, the processing the first multi-sample container at the first processing station comprises contacting a processing fluid with the biological samples in the first multi-sample container (e.g., injecting the processing fluid into the first multi-sample container while maintaining a substantially laminar stream and/or isolating injectors from the sample container). In at least one example, the isolating comprises recessing injectors in a dispensing head. In still a further example, the means for isolating comprises means for controlling relative amounts of processing fluid dispensed into each of the biological samples (e.g., supplying processing fluid to multiple injection conduits from a proximate reservoir through a supply conduit).

In yet a further example, the processing the first multi-sample container at the first processing station comprises agitating the first multi-sample container and/or creating an aperture for at least one sample in the first multi-sample container. In some such examples, the creating comprises piercing a re-sealing or non-resealing material. In further examples, the processing also comprises removing of a fluid through the aperture (e.g., creating a pressure differential between an interior well of the multi-sample container and the aperture, wherein the pressure is greater in the well than at the aperture by drawing or pushing air)

In still further examples, the moving comprises urging along a track by pushing, pulling, and/or sliding.

In an even further example of the invention, a system is provided for harvesting polynucleotides from a growth plate in which bacteria that include the polynucleotides reside and in which growth media reside. The system comprises: means for inserting into the growth plate a lysis fluid; means for agitating the lysis fluid and bacteria in the growth plate; means for creating an aperture in the growth plate; means for inserting a wash fluid into the growth plate; means for passing a gas through the growth plate; means for inserting a solubilizing fluid into the growth plate; and means for creating a pressure differential across the processing plate whereby DNA is removed from the growth plate.

In some examples, the lysis fluid comprises a buffer. In further examples, the lysis fluid comprises a substantially neutral pH. In still further examples, the lysis fluid comprises a non-alkaline fluid. In yet further examples, the lysis fluid comprises a salt (e.g., an acetate-containing salt consisting essentially of a TRIS acetate salt). In some examples, the salt consists essentially of a chaotropic salt.

In still further examples, the lysis fluid comprises a detergent.

In even further examples, the wash fluid comprises a buffer and/or an enzyme (e.g., an RNA-specific enzyme and/or a non-DNA specific enzyme). In some examples, the wash fluid poorly solubilises DNA. In still further examples, the wash fluid solubilises lipids, chaotropic salts, and carbohydrates, faster than the wash fluid solubilises DNA. In still further examples, a majority of the wash fluid comprises alcohol (e.g., between 30% and 98% by volume). In yet a further example, the solubilizing fluid comprises water.

In yet further examples, the gas comprises air.

In an even further example of the invention, there is provided a means for removing the wash fluid from the growth plate and a means for reinserting the wash fluid into the growth plate. In at least one example, the means for removing and means for reinserting operate before said means for passing a gas. In at least one other example, the means for removing and the means for reinserting occur after said passing a gas.

In still a further example, the system further comprises means for holding the wash fluid in the growth plate for a period long enough for an enzyme in the wash fluid to degrade RNA from silica in the growth plate (e.g., between about one minute and about five minutes).

Foam can also be a problem in some examples, and to avoid that formation, in some examples of the invention, a means is provided for preventing foam that comprises means for removing air from contact with the lysis fluid in the growth plate during removal of the lysis fluid. In at least one example, the means for removing air comprises means for inserting of the wash fluid into the growth plate before the removal of the lysis fluid.

In yet a further example, the means for inserting the wash fluid operates before said means for removing the lysis fluid.

In still a further example, a means is provided for inserting a further wash fluid after removal of the wash fluid having an alcohol content greater than the alcohol content of the wash fluid. In at least one example, the means for passing a gas comprises means for pulling air through the growth plate. In another example, the means for passing a gas comprises means for pushing air through the growth plate.

In yet another example, the means for inserting a solubilizing fluid in the growth plate comprises means for inserting water in the growth plate and/or the means for creating a pressure differential comprises means for placing a collection plate near the aperture and drawing a gas from at least one edge of the collection plate.

In still a further example of the invention, a method is provided for harvesting polynucleotides from a growth plate in which bacteria that include the polynucleotides reside and in which growth media reside, the method comprising: inserting into the growth plate a lysis fluid; agitating the lysis fluid and bacteria in the growth plate; creating an aperture in the growth plate; inserting a wash fluid into the growth plate; passing a gas through the growth plate; inserting a solubilizing fluid into the growth plate; and creating a pressure differential across the processing plate whereby DNA is removed from the growth plate.

In at least one example, the method further comprises removing the wash fluid from the growth plate and reinserting the wash fluid into the growth plate. In some such examples, the removing and reinserting occur before said passing a gas. In some other examples, the removing and reinserting occur after said passing a gas.

In still other examples, the method further comprises, holding the wash fluid in the growth plate (e.g., for a period long enough for an enzyme in the wash fluid to degrade RNA from silica in the growth plate).

In still another example, the method further comprises preventing foaming of the lysis fluid during removal of the lysis fluid (e.g., by removing air from contact with the lysis fluid in the growth plate during removal of the lysis fluid). In at least one such example, the removing of air comprises insertion of the wash fluid into the growth plate before the removal of the lysis fluid (e.g., before removing the lysis fluid). In some such examples, the method further comprises inserting a further wash fluid after removal of the wash fluid.

In some further examples, the passing a gas comprises pulling and/or pushing air through the growth plate.

In still further examples, the inserting a solubilizing fluid in the growth plate comprises inserting water in the growth plate and the creating a pressure differential comprises placing a collection plate near the aperture and drawing a gas from at least one edge of the collection plate.

According to yet another example of the invention, a biological sample preparation device (sometimes known as a “plate”) is provided comprising: a plurality of reaction volumes wherein each reaction volume is in a fixed relation to other reaction volumes; and a recessed sample extraction location for each reaction volume. Each of the recessed sample extraction locations comprises at least one projection beyond each of said recessed sample extraction locations.

In at least one example of the invention, a skirt resides around the recessed sample extraction locations and comprises a sealing edge. In at least some examples of the invention, an elongate member resides around each of said recessed sample extraction locations and as any of a variety of cross-sectional shapes (e.g., cylindrical, or other curved shape and/or polygonal shape, such as a triangle, parallelogram, rectangle, square, pentagon, hexagon, etc.).

In some examples, the reaction volumes comprise an open end of the reaction volume (which is an elongate shape).

In yet other examples, the reactions volumes are spaced from each other with spacer members between said plurality of the reaction volumes, while, in still further examples, the reaction volumes reside in a substantially unitary structure defining said plurality of reaction volumes and defining said recessed sample extraction location for each reaction volume. An openable, centrifugal sample extraction member located at each of said recessed sample extraction locations that comprises a piercable material is provided in some examples (e.g., a plastic). In some examples, the openable member is of a soluble and/or meltable material. In still further examples, the material is photo-reactive material.

In still a further example of the invention, a binding material (e.g., silica) is present in the reaction volumes. For example, in some embodiments of the invention, lysing and binding of polynucleotides occurs in one location in substantially the same process step. Diatomaceous earth is used in at least one example, and a powder form of a binding material is used in further examples. In some examples, the binding material comprises silicon dioxide. In further examples, polynucleotide growth media resides in at least one of the plurality of reaction volumes, and silica and polynucleotide growth media reside in at least one of the plurality of reaction volumes in still further examples.

In a further example of the invention, a system is provided for producing a plurality of polynucleotides from at least one colony of host cells, the system comprising: means for maintaining a reaction volume for each polynucleotide; means for maintaining a distance between the reaction volumes; means for receiving the plurality of polynucleotides in the reaction volumes; and means for providing a sample extraction path from each reaction volume.

In at least one such system, the system further comprises means for providing at least one recess of at least one sample extraction path (e.g., at least one projection beyond said means for providing at least one sample extraction path). In some examples, the at least one projection resides between a plurality of means for providing a sample extraction path, around a plurality of means for providing a sample extraction path, or around all of the means for providing a sample extraction path.

In some examples, the at least one projection comprises a single projection around all of the means for providing a sample extraction path or multiple projections wherein said multiple projections, together, define a recess in which there resides plurality of means for providing a sample extraction path. In at least one example, the means for providing at least one recess of at least one sample extraction path comprises a skirt around all the means for providing a sample extraction path from each reaction volume.

In yet another example of the invention, a device is provided comprising: at least two multi-sample, biological sample container processing stations; guides between the at least two multi-sample, biological sample container processing stations; and stops at a plurality of the at least two multi-sample, biological sample container processing stations.

In some examples, at least one processing station comprises a seal positioned and arranged for contact with a sample container. In further examples, the least one processing station comprising a seal further comprises a pressure aperture. In still further examples, a slideable actuator is provided that is mounted between the at least two processing stations.

In still another example of the invention, a system is provided for manipulation of multi-sample biological sample containers, the system comprising: means for receiving a first sample container, at a first processing location; means for guiding the first sample container to a second processing location; means for holding the first sample container at the second processing location; and means for receiving a second sample container at the first processing location.

In at least one example, the system further comprises means for pushing the multi-sample container between the first and the second processing locations (e.g., a linear motion actuator) such as an elongate member residing between the first and the second processing stations wherein the elongate member includes a protrusion slideably connected between the first and the second processing stations.

In at least one example, the system comprises means for pulling and/or means for pushing the multi-sample container between the first and the second processing locations and a means for sliding the multi-sample container between the first and the second processing locations.

In some examples, the means for sliding comprises a grooved track, and the means for receiving comprises a first recess in a track. In some examples, the means for guiding comprises guides along a track and the means for holding comprise stops in the track. In yet further examples, the means for receiving a second sample container at the first processing location comprise a second recess in the track.

In still another example of the invention, a method is provided, wherein the method is for manipulation of multi-sample biological sample containers. The method comprises: receiving a first sample container, at a first processing location; guiding the first sample container to a second processing location; holding the first sample container at the second processing location; and receiving a second sample container at the first processing location.

In at least one example, the method further comprises pulling and/or pushing the multi-sample container between the first and the second processing locations. In a further example, the method further comprises sliding the multi-sample container between the first and the second processing locations.

In still another example of the invention, a dispenser of biological substance process fluid is provided. The dispenser comprises a reservoir comprising: a biological substance process input port; a plurality of dispense ports; and a set of dispensing protrusions connected to the dispense ports.

In at least one example, the plurality of dispense ports is arranged in a substantially two-dimensional array, and the reservoir comprises a cross-section that tapers from said input port. In further examples, the dispensing protrusions are recessed in a guard member in a set of elongated recesses.

In a further example of the invention, a system is provided for dispensing a biological substance process fluid from a dispensing container to multiple samples of biological substances. The system comprises: means for receiving from the dispensing container a multiple sample amount of biological substance process fluid, wherein the multiple sample amount is sufficient for processing the multiple samples of biological substances; means for dividing the amount into a set of individual sample amounts in a multidimensional array; and means for substantially simultaneously dispensing the set of individual sample amounts to a set of individual samples.

In at least one example, the means for receiving comprises an accumulator of the multiple sample amount proximate a set of individual sample dispense paths. In a further example, the means for dividing comprises a manifold of individual sample dispense paths from a reservoir. In yet a further example, the means for dispensing comprises means for streaming the set of individual sample amounts to the multiple samples (e.g., an injector outside a container holding the multiple samples). In at least one more specific example, the means for streaming comprises a recessed injector that is substantially stationary during the receiving, dividing, and dispensing.

In still a further example of the invention, a method is provided for dispensing a biological substance process fluid from a dispensing container to multiple samples of biological substances, the method comprising: receiving from the dispensing container a multiple sample amount of biological substance process fluid, wherein the multiple sample amount is sufficient for processing the multiple samples of biological substances; dividing the amount into a set of individual sample amounts in a multidimensional array; and substantially simultaneously dispensing the set of individual sample amounts to a set of individual samples.

In at least one example, the receiving comprises accumulating the multiple sample amount proximate a set of individual sample dispense paths and the dividing comprises providing a set of individual sample dispense paths from a reservoir.

In still a further example of the invention, the dispensing comprises streaming the set of individual sample amounts to the multiple samples (e.g., injecting from outside a container holding the multiple samples).

In still a further example of the invention, a linear automated processing device is provided having at least two stations and performing a method for mixing (contacting two or more substances) in a plate the method comprising: introducing a plate; guiding the plate from a first station into a second station; said second station having a moveable portion; temporarily retaining the plate on said moveable portion; and imparting motion to said movable portion.

In another example of the invention, a method and system are provided for creating two or more apertures in a plate having two or more vessels each vessel comprising a nozzle portion, the method comprising: providing a plate; providing at least two means for creating an aperture; aligning at least two of the nozzle portions with a corresponding aperture creating means; guiding said at least two nozzle portions to contact a corresponding aperture creating means; and creating an aperture in at least two of the nozzle portions.

In still further examples of the invention, a reservoir area is provided to distribute the fluid being dispensed by the dispense nozzles and reduce the pressure gradient between nozzles due to the fluid flow. A plenum is provided and is constructed so as to provide a generally equal pressure at the inlet of all dispense nozzles and thereby improve accuracy. When air is trapped in the plenum area the compressibility of the air can cause dripping and inaccurate volumes to be dispensed. To aid in the removal of trapped air in the plenum, the dispense head reservoir comprises a sloped top area to allow trapped air to flow into and collect near the purge valve.

In yet another example, in a linear automated processing device having at least two stations a method is provided for uniting a first plate and a second plate, the method comprising: introducing a first plate into a first station; guiding the first plate from a first station into a second station; introducing a second plate into a second station; moving the first plate into the second station; moving the second plate underneath the first plate in the second station; and lifting the second plate to unite the second plate and the first plate.

In still another example, a linear automated processing device having at least two stations is provided using a method for transferring a substance from a first plate to a second plate, the method comprising: providing an assembly comprising a first plate and a second plate into a first station, said first plate comprising a substance to be transferred to the second plate; introducing said assembly into a first station; guiding the first plate from a first station into a second station; creating a differential pressure between the; moving the first plate into the second station; moving the second plate underneath the first plate in the second station; and lifting the second plate to unite the second plate and the first plate.

In yet a further example, in a linear automated biological sample processing device having a track and at least two stations a method is provided for transferring a plate from a first station to a second station, the method comprising: providing a track having a first station and a second station; introducing a plate into a first station; and transferring the plate from a first station into a second station while maintaining contact between the track and the plate.

In still a further example of the invention, a kit is provided for separating at least one target substance from a sample comprising biological cells, the kit comprising: one or more buffers comprising at least one re-suspension substance, at least one lysing substance, and at least one binding promoting substance; a retaining substance; and a container for receiving the cells, retaining substance and buffers such that when said cells, and buffers are contacted in said container re-suspension, lysis and binding to said retaining substance occur generally simultaneously.

An example embodiment of the current invention provides a kit for separating at least one target substance from a sample comprising biological cells, the kit comprising one or more buffers such as a re-suspension substance such as TE. Other suitable buffers as would be obvious to those skilled in the art can be substituted or the re-suspension substance could be eliminated and the lysing substance or binding promoting substance can be used as the re The kit also comprises a lysing substance.

In still a further example, there is provided a method for culturing cells and separating a target substance from the cells in the same container, the method comprising: providing a container for culturing the cells; providing cells to be cultured; culturing the cells in said container; introducing a retaining substance into the container; introducing a substance that aids retention of the target substance to the retaining substance into the container; introducing a substance that aids even dispersion of the cells and target substance into the container; introducing a substance that lyses the cells into the container; and contacting the cells and introduced substances in said container.

In even another example, a method is provided for separating a target substance from a substance comprising biological cells in a container, the method comprising: introducing the cells into the container; introducing a retaining substance into the container; introducing a re-suspending substance into the container; introducing a lysing substance into the container; introducing a binding promoting substance into the container; causing the cells to contact the re-suspending substance, lysing substance and binding promoting substance generally simultaneously.

In another example, a method is provided for improving the yield of a target substance from biological cells, the method comprising: providing a container; introducing into the container a mixture comprising a powdered substance, a growth media, and biological cells; and culturing the cells in said mixture.

In still a further example, a method is provided for separating a target substance from a substance comprising biological cells, the method comprising: providing biological cells; providing a retaining substance; lysing the cells; providing a retention promoting substance; contacting the cells and the lysing substance; and retaining the target substance in the presence of the products of said lysing.

In a further example, a method is provided for separating a target substance from a substance comprising biological cells, the method comprising: introducing a lysing substance into the container; introducing a retaining substance into the container; contacting the cells and the lysing substance; providing a retention promoting substance; and retaining the target substance in the presence of the products of said lysing.

A method is also provided for improving the separation of a target substance from a mixture comprising biological cells and a supernatant in a container, the method comprising: providing a container; introducing a substance comprising biological cells into the container; introducing a powdered substance into the container; and separating cells and powder from the supernatant.

Still another method that is provided according to another example of the invention is a method for removing impurities while separating a target substance from a substance comprising biological cells, the method comprising: providing a container having at least a sample introducing end and a supernatant removal end; introducing a retaining substance into the container; introducing a biological cells lysate into the container; contacting the cell lysate and the retaining substance in the container; introducing a wash buffer so as to separate the cell lysate from the sample introducing end; creating a differential pressure between the sample introducing end and the supernatant removal end; and passing the cell lysate past at least a part of the retaining substance and through the supernatant removal end while maintaining separation of the cell lysate from the sample introducing end with the wash buffer.

A wash buffer is provided in still another example for removing unwanted substances from a sample comprising at least one target substance and at least one unwanted substance, the buffer comprising an enzyme for digestion of the unwanted substances.

A further method that is provided is a method for washing a mixture comprising a target substance and at least one un-wanted substance, the method comprising: contacting the mixture with a wash buffer comprising an enzyme capable of degrading said at least one un-wanted substance; allowing the enzyme to degrade said un-wanted substance; and removing said wash buffer from said mixture.

In at least one example of the invention, a plate is provided that can bind the target substance (such as DNA, RNA, proteins, etc.) and that is compatible with cells to be grown. In at least one example, a plate includes a sealed bottom (nozzle) that can bind the target substance. (such as DNA, RNA, proteins, etc.).

Further example embodiments will occur to those of skill in the art, and the above are given by way of example only.

### BRIEF DESCRIPTION OF THE DRAWINGS

FIG. 1 shows a view of a processing station used for processing biological samples.

FIG. 1A shows a cross-sectional view of a processing plate half-way between processing stations.

FIG. 1B shows a top view of one means for transferring a first processing plate from a first processing station to a second processing station.

FIG. 1C shows a cross-sectional view of a processing plate aligned for processing at a first processing station.

FIG. 1D shows a cross section of the processing plate in FIG. 1C as it is being transferred between processing stations.

FIG. 1E shows a means for returning an actuator so that it may transfer a second processing plate from a first station to a second station.

FIG. 1F shows one example embodiment of a 96-well format arrangement of vessels.

FIG. 1G shows a cross-sectional view of some processing protrusions located in the processing plate from FIG. 1F.

FIG. 1H shows a cross section of pressure apertures and seals.

FIG. 1I shows a track for guiding processing plates from one processing location to another.

FIG. 1J shows a gasket and a recess in a processing station for accepting the gasket.

FIG. 2 shows one example embodiment of a processing plate delivery system.

FIG. 2A shows further details of the delivery system of FIG. 2.

FIG. 3 shows a cross section of one example embodiment of a fluid delivery system.

FIG. 3A shows a further example embodiment of a fluid delivery system and reservoir.

FIG. 3B shows yet a further example embodiment of a fluid delivery system and reservoir.

FIG. 4 shows one example embodiment of a shaker.

FIG. 4A shows an eccentric bolt.

FIG. 4B shows one possible cross-sectional bottom view of the shaker shown in FIG. 4.

FIG. 4C shows a cross section of one example embodiment of an alignment guide for the shaker shown in FIG. 4.

FIG. 5 shows one example embodiment of a piercer.

FIG. 5A shows a further detail of one example embodiment of the press mechanism for the piercer in FIG. 5.

FIG. 5B shows a cross section of a processing plate prior to be pierced by a piercer.

FIG. 5C shows a cross section of a processing plate after piercing.

FIG. 5D shows an alternative embodiment of a piercer member and spring-loaded guard.

FIG. 5E shows a cross section of an alternative embodiment of a processing plate prior to be pierced by a piercer.

FIG. 5F shows a cross section of an alternative embodiment of a processing plate after piercing.

FIG. 6 shows one example embodiment of a collection plate delivery system.

FIG. 6A shows a cross-sectional view of FIG. 6.

FIG. 6B shows another cross-sectional view of FIG. 6.

FIG. 7 shows an elute station.

FIG. 7A shows a cross section of an elute station with a processing plate and collection plate located for processing.

FIG. 7B shows another example embodiment of an elute station.

FIG. 7C shows a close-up view of an alternative embodiment of a processing well and collection well that is useful in the present invention.

FIG. 8 shows one example embodiment of a collection plate sealer.

FIG. 8A shows a further detail of one example embodiment of a collection plate seal delivery system.

FIG. 8B shows a further detail of the collection plate seal delivery system from FIG. 8A.

FIG. 9 shows one example embodiment of a collection plate stacker.

FIG. 9A shows a cross section of one example embodiment of the collection plate stacker from FIG. 9.

FIG. 10A shows one means for transferring a processing plate from one processing station to another.

FIG. 10B shows another means for transferring a processing plate from one processing station to another.

### DETAILED DESCRIPTION OF EXAMPLE EMBODIMENTS OF THE INVENTION

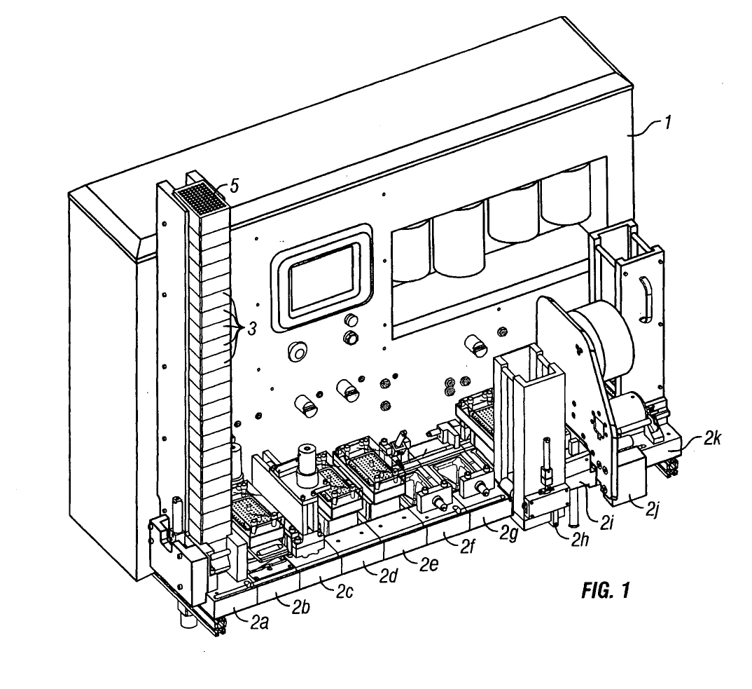

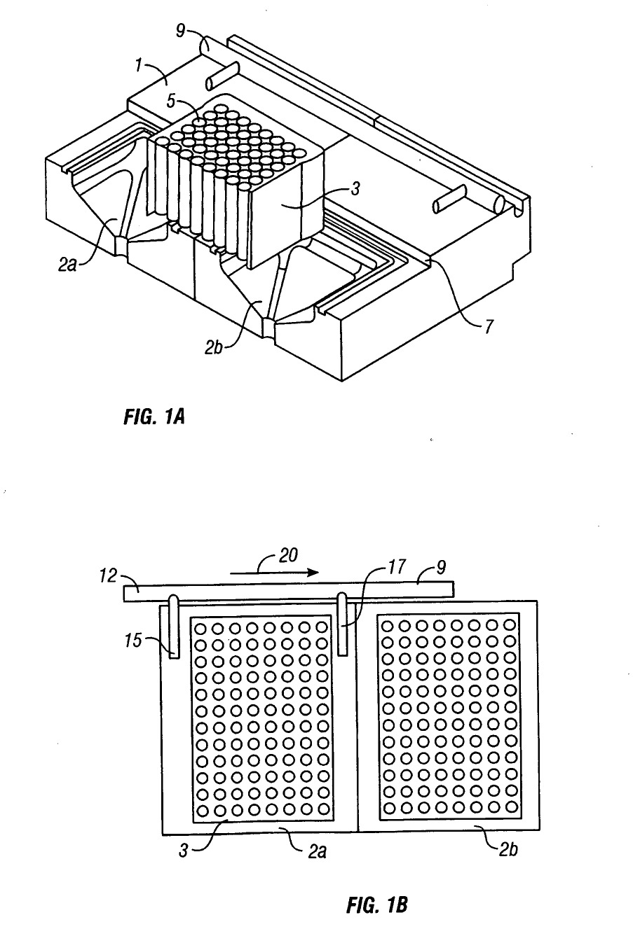

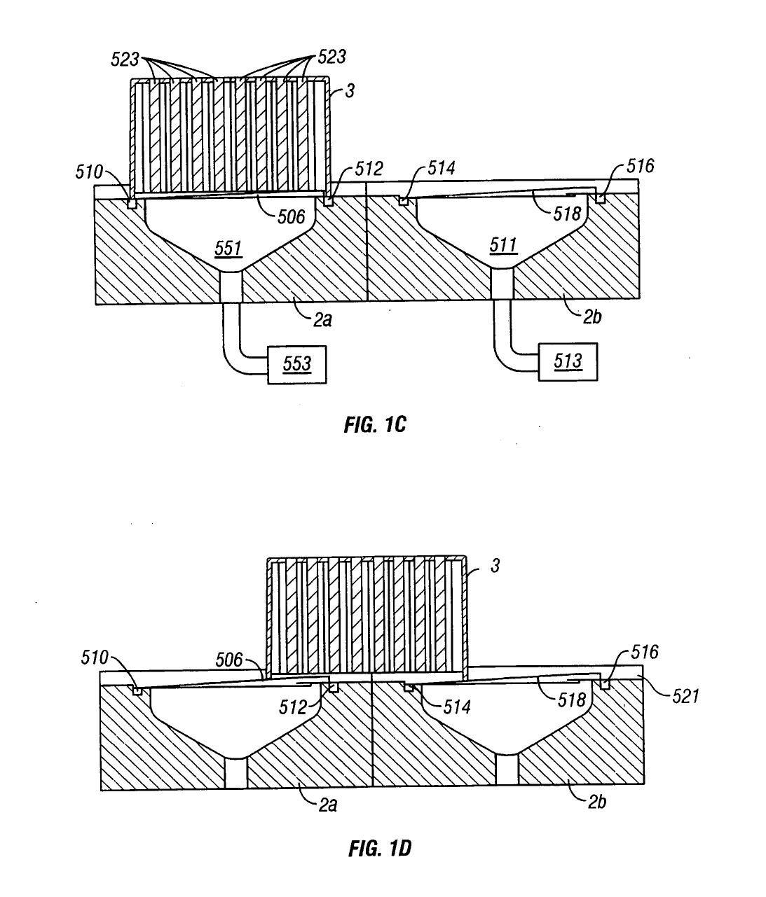

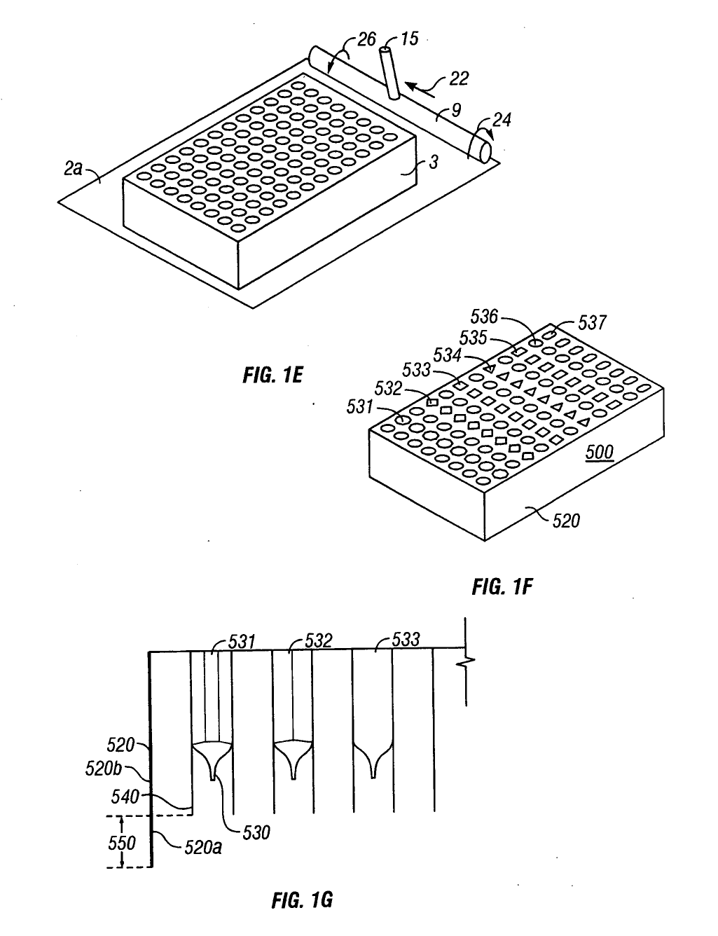

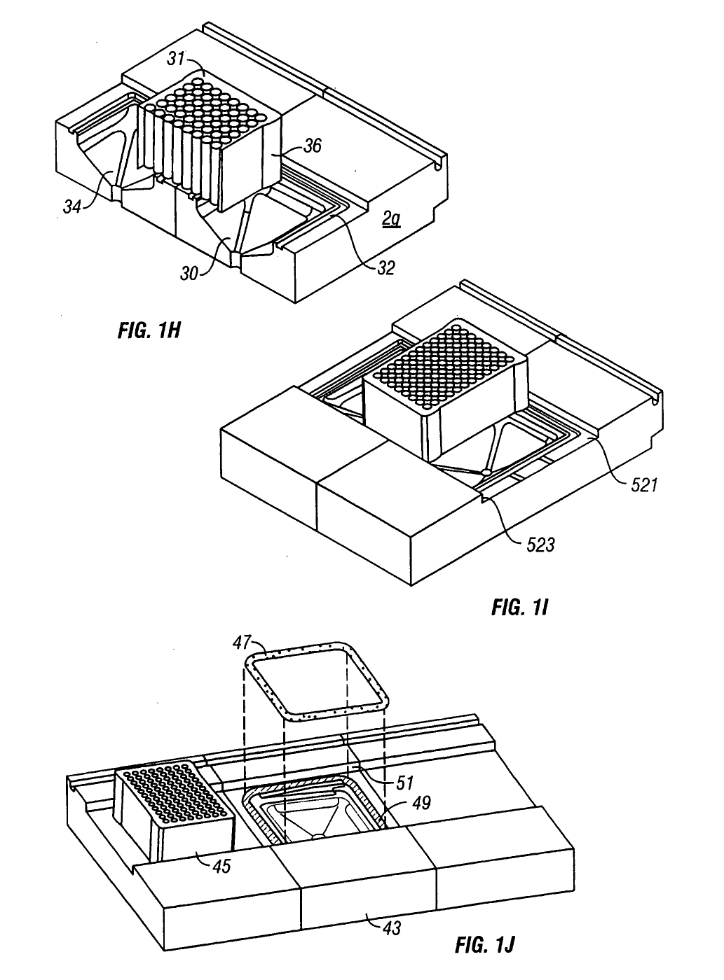

Referring now to FIG. 1, a device 1 is seen for processing containers 3 having a plurality of biological sample wells 5 wherein at least one of the wells includes a biological sample (not shown). In the illustrated example, the device 1 comprises at least two processing stations (in the illustrated example, there are 11, 2a-2k). FIG. 1A shows a close-up sectional view of two processing stations of device 1 in FIG. 1 where a sample guide 7 is seen between the at least two processing stations 2a and 2b. An actuator 9 moves container 3 from at least one processing station (e.g., station 2a) to another processing station (e.g., station 2b).

Referring now to FIGS. 1A and 1B, an example of a slideable actuator 9 is illustrated, according to an example of the present invention, in which actuator 9 comprises a shaft 12 with push rods 15 and 17 positioned and arranged between the processing stations 2a and 2b and used to move processing plate 3 from one station 2 to another. In various embodiments of the present invention, one advantage of using separate push rods 15 and 17 for each processing plate at each station 2a and 2b is that accurate positioning of processing plates is easier than if only one push rod is used to move multiple processing plates, not shown, between multiple processing stations. In still other embodiments of the present invention, other advantages of using separate push rods 15 and 17 for each processing plate at each station 2a and 2b is that during operation, the system will run with one plate between stations, and also, the system will run with multiple plates between stations, and alternatively, when the system consists of more than two processing stations with push rods at each station, the system will run with a gap in the line of plates being processed. FIG. 1C shows a cross-sectional view of one example embodiment of the illustration in FIG. 1B where processing plate 3 is located for accurate processing at station 2a. Plate 3 is located by stops 510 and 512. In alternative embodiments, plate 3 is located over seals 510 and 512. In still another alternative embodiment, plate 3 is located over a single seal.

During operation, in at least one example of the invention, actuator 15, shown in FIG. 1B contacts container 3, pushing it over stops 510 and 512 at station 2a, illustrated in FIG. 1C, along guides, not shown, up ramps 506 and 518 to station 2b, where ramps 506 and 518 separate plate 3 from contacting 510 and 514 to reduce friction with seals and aid in more precise positioning of the container. FIG. 1D illustrates container 3 part-way through a transfer from station 2a to 2b where container 3 is “riding” or “traveling” on and over ramps 506 and 518, guided by at least sample guide 521 during the transfer.

During operation of the device of FIG. 1A, in at least some examples of the invention, at least one multi-sample, biological sample processing container is guided between stations 2a and 2b by guide 7 and positioned over stops 510, 512, 514, and 516 (as illustrated by FIG. 1C) at each of the illustrated stations. In an alternative embodiment, 510 and 512 comprise a single seal or “o-ring” positioned in a groove in station 2a, and 514 and 516 comprise a single seal positioned in a groove in station 2b.

Referring now to FIG. 1E, during operation, in at least one example of the invention, after transferring a given processing plate, not shown, to the next processing station, actuator 15 returns to station 2a, its “ready position,” and is positioned to accept another processing container 3 for transfer between stations 2a and the next station. In another embodiment of the present invention, actuators 15 and 17, illustrated in FIG. 1B, return simultaneously to their ready positions and are positioned to accept processing containers located at processing stations 2a and 2b. In yet another example embodiment, in a system of multiple processing stations where multiple processing plates are processed, means for transferring processing plates from one processing station to another, operate simultaneously. Referring back to FIG. 1E, in an example embodiment of the present invention, actuator 9 is rotated 24 a sufficient distance around its center of rotation to allow actuator 15 to be “pulled” toward 22 its ready position without contacting plate 3 during the travel. After rotation 24, actuator 9 travels a distance 22 sufficient for actuator 15 to reach its ready position in proximity to a next processing container 3 for transfer between stations 2a and 2b. Actuator 9 is rotated 26 a sufficient distance around its center of rotation to allow actuator 15 to contact a next processing container 3 for transfer as illustrated by FIG. 1B above.

Referring now to FIG. 1F, a processing plate 500 is shown. In this example embodiment, 96 wells are shown arranged in a single plate consisting of skirt 520 defining an inner surface 520a and an outer surface 520b as shown in FIG. 1G and designed to connect to a seal, not shown, for creating a pressure differential between the inner surface and the outer surface of the plate.

Wells 531-539 are a small subset of the 96 wells. It should also be noted that although many wells are shown as circular cylinders, in various example embodiments, the shape of each, several, or all wells may be varied as is shown by wells 531-539. In at least one example embodiment of the present invention, wells 531-539 comprise a hollow cylindrical body having an open end and a spherical closed end. In another example embodiment, all processing wells are made of a thermoplastic material. In other embodiments, any suitable material and any suitable shape that will occur to those of ordinary skill in the art is used. Referring now to FIG. 1G, shown is a cross section of a portion of plate 500 with a skirt 520, a well for processing biological materials 531, a well base 530, and well guard member 540. In some example embodiments of the present invention, well 531 comprises a cylindrical body having an open end and a closed end 530. In other example embodiments, well 531 comprises a cylindrical body having an open end and a flattened closed end, not here illustrated. In other example embodiments, well 531 comprises a cylindrical body having an open end and a spherical closed end 530. In other embodiments, any suitable shape that will occur to those of ordinary skill in the art is used. In some example embodiments of the present invention, well guard member 540 extends beyond well base 530 and skirt 520 extends beyond the base of well guard member 540. The distance 550 between the base of skirt 520 and guard member 540 creates a contamination barrier during biological sample processing, as explained below. In other example embodiments, not here illustrated, well guard member 540 extends below skirt 520.

It should be noted that although 96 wells are shown, the number of wells can be greater than or less than 96 and may be arrayed differently than illustrated in FIG. 1F as long as the design of a given processing station, not shown, and given collection plates, described below, takes into account the processing plate well design arrangement actually used during processing.

Referring to FIG. 1H, in at least one example of the invention, a station 2g having a pressure aperture 30 also includes a seal 32 for interaction with a sealing surface 34 on the skirt 36 of plate 31. The interaction of sealing surface 34 and seal 32 allow a reduction in pressure through pressure aperture 30 to draw fluid and other material through apertures, not shown, in the sample wells of plate 31.

In various examples, the processing stations 2 are in various forms. For example, in the example illustrated in FIG. 1, processing station 2a comprises a processing plate dispenser, station 2b comprises a fluid dispenser and an agitator, station 2c comprises a piercer, while station 2d comprises a fluid dispenser and a pressure aperture and seal, positioned and arranged for interaction with the container. Station 2f comprises a pressure aperture and a seal, positioned and arranged for interaction with the container. Station 2h comprises a dispenser of collector plates and a further fluid dispenser, station 2i comprises a further pressure aperture and a processing plate ejector, while station 2j comprises a collector plate sealer, and station 2k comprises a collector plate stacker. In various embodiments of the present invention, the stations described above are combined in any configuration or permutation or configurations that is useful for processing multiple processing containers.

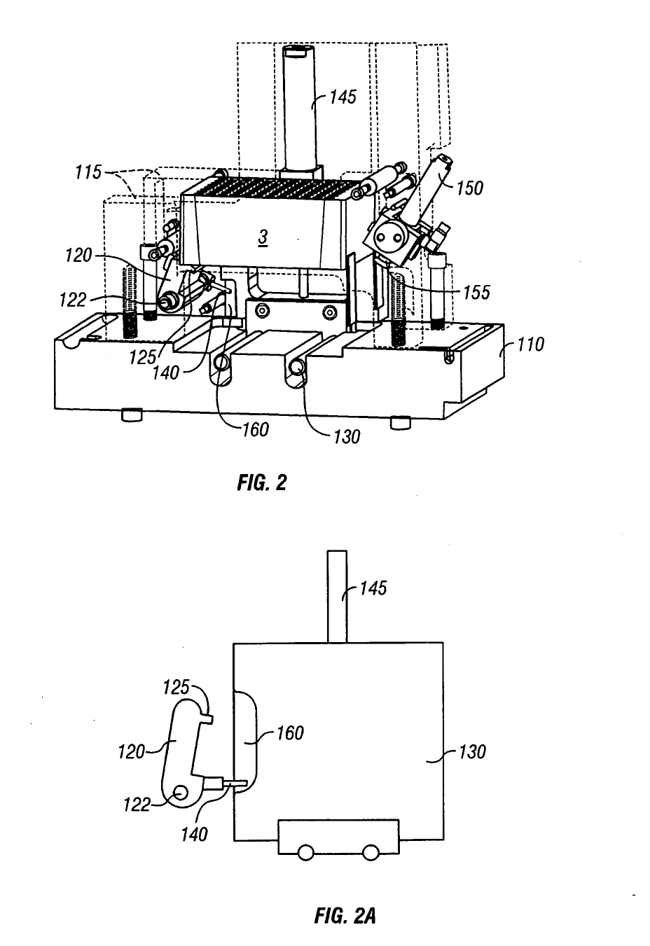

Referring now to FIG. 2, an illustration of an example processing plate dispenser 100 that is useful according to some examples of the present invention is seen in which processing plate 3 is in position above processing station 110. In some examples of the present invention, processing station 110 is the same as processing station 2a in FIG. 1. Escapement mechanism 120 holds processing container 3 and any other processing containers stacked above 3, not shown, above station 110 via an escapement lip 125 and vertical rails 115. Processing container 3 is “dropped” or “delivered” onto station 110 when elevator 130 is raised by actuator 145 to just below processing container 3. In some alternative embodiments, elevator 130 is raised by actuator 145 and contacts the bottom of processing container 3. In some embodiments of the present inventions, as elevator 130 rises, actuator bar 140 is contacted by elevator 130 in a manner that lifts actuator bar 140, causing escapement mechanism 120 to rotate around escapement bolt 122. When escapement mechanism 120 rotates, escapement lip 125 is moved away from the base of processing container 3 allowing processing container 3 and any other processing containers above 3, not shown, to fall onto elevator 130. As elevator 130 lowers to processing station 110, actuator bar 140 is allowed to lower and escapement mechanism 120 rotates back into a position so that escapement lip 125 will contact the base of any processing containers above 3, allowing only processing container 3 to be lowered to processing station 110.

In some examples of the present invention, escapement mechanism 120 is held into an initial “closed” position, as shown in FIG. 2, by a spring, not shown, that puts torsional force on escapement mechanism 120 in the closed direction. Actuator bar 140 sits in a groove 160 cut into elevator 130, see FIG. 2A. In the illustrated example, as elevator 130 rises, the base of groove 160 rises and contacts actuator bar 140, lifting 140 up. When elevator 130 lowers, the spring force against which actuator bar 140 and elevator 130 are pushing, returns escapement mechanism 120 to the closed position.

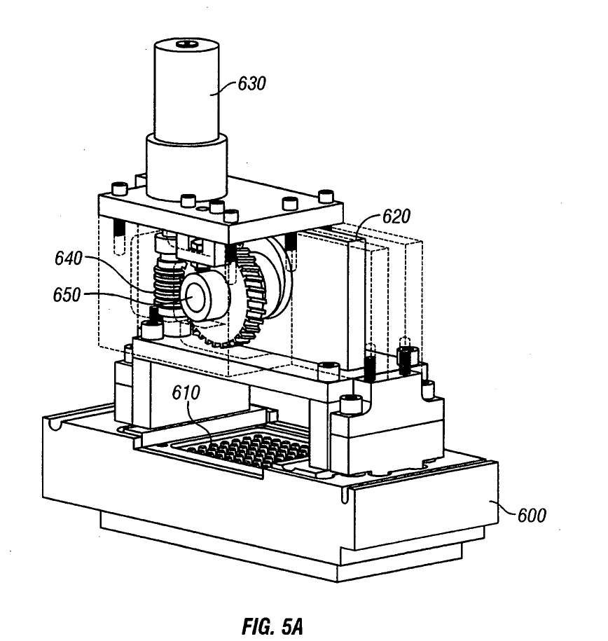

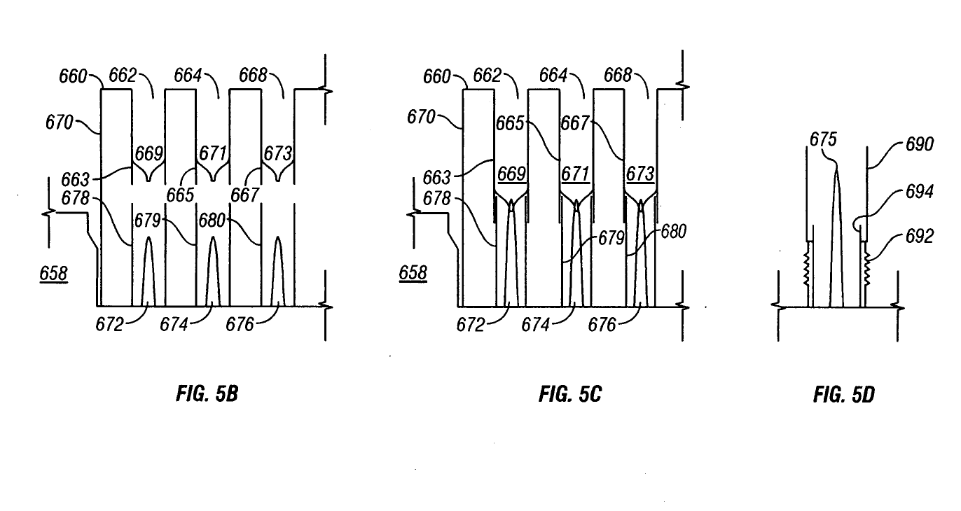

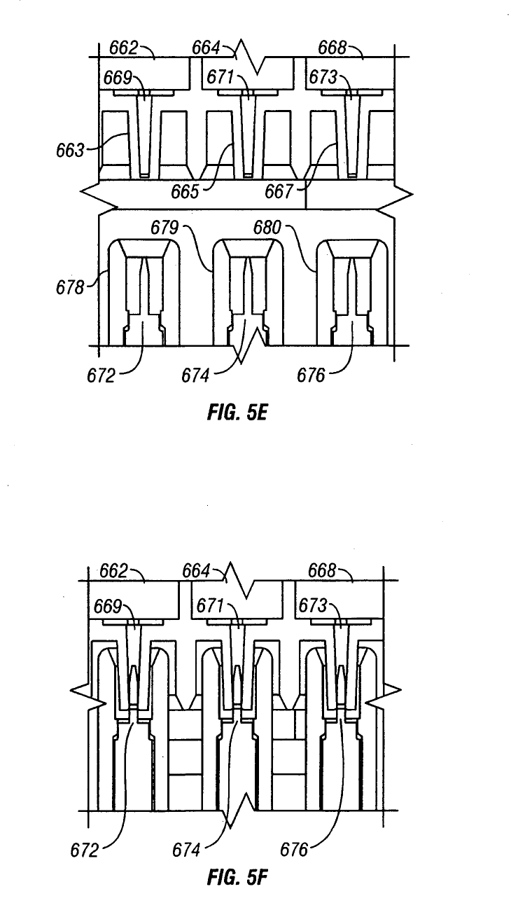

In some examples of the present invention, a stripping piston 150 is used to dislodge processing container 3 from containers above 3, not shown, that processing container 3 has become “stuck” to. Stripping piston 150, as illustrated in FIG. 2 contains a air actuated piston that extends a “tapping” head 155 such that the tapping head will contact a stuck processing container 3 sufficiently hard enough to dislodge the container, allowing it to fall onto processing station 110. An alternative embodiment for lowering processing containers onto a processing station is explained below and illustrated by FIG. 5. Still more alternative embodiments for lowering processing containers onto a processing station may be conceived by those with skill in the art. In various examples of the invention, actuator 145 comprises an air driven piston, a worm screw mechanism, a weights and pulley configuration, and/or one of many other actuators and combinations of actuators for raising and lowering elevator 130. It should also be noted, in some alternative embodiments of the present invention, that actuator 145 is located below processing station 110. In still further embodiment of the present invention, actuator 145 is located in a variety of orientations that will occur to those of skill in the art.

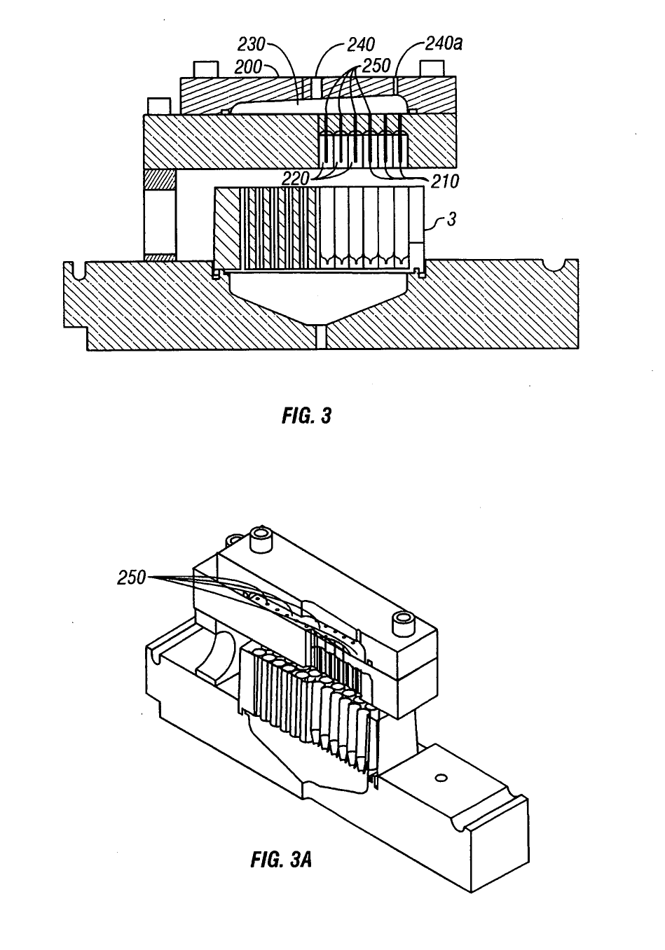

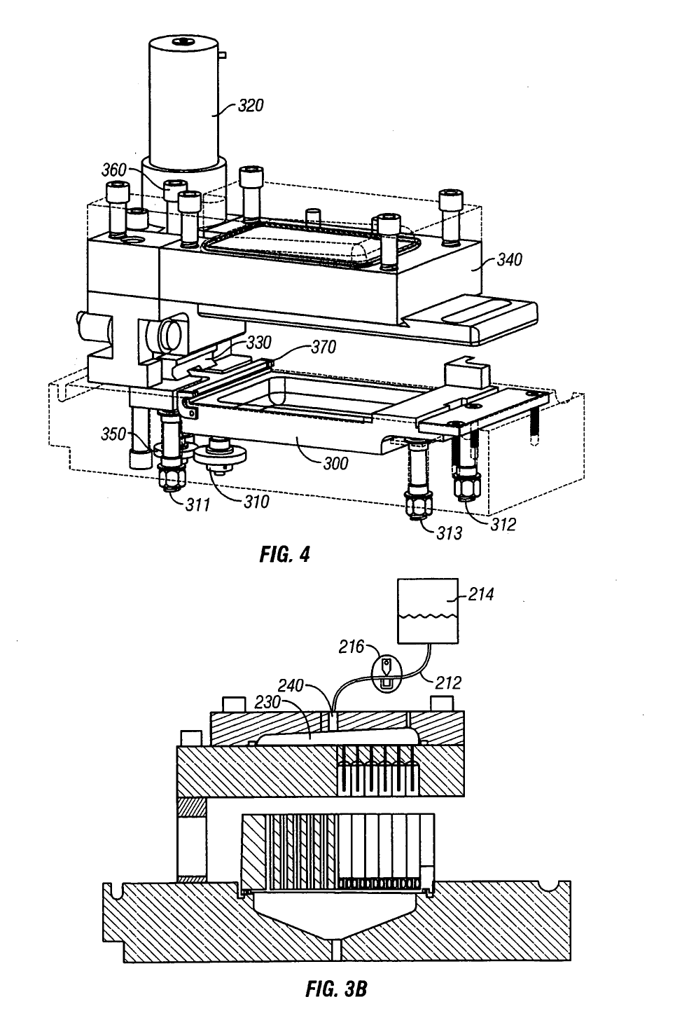

Referring now to FIGS. 3 and 3B, an illustration of a fluid dispenser that is useful according to some examples of the present invention is seen in which the processing fluid dispenser 200 comprises a set of injectors 210 that are recessed in a guard member 220 that is held stationary with respect to the sample container 3. In at least one example of the dispenser, a reservoir 230 is provided that includes a biological substance process input port 240, purge port 240a having a suitable valve, not shown, a plurality of dispense ports 250 (illustrated for further clarity in FIG. 3A), and a set of dispensing protrusions 210 connected to the dispense ports. In the illustrated example, the plurality of dispense ports is arranged in a substantially two-dimensional array. Also in the illustrated example, the reservoir comprises a cross-section that tapers from said purge port 240a for the purpose of collecting gas trapped in reservoir 230 at purge port 240a for removal through a valve at 240a. In several embodiments of the present invention, purge port 240a is used to remove excess compressibility from reservoir 230 to prevent dripping and inaccuracy in dispensing volumes. Reservoir 230 is sized so that the fluid head pressure at all the dispense ports is relatively equal allowing for all fluid dispensed from all the dispense ports 250 to be delivered through dispensing protrusions 210 at approximately the same fluid flow rate. Other cross-sections and means for accomplishing the same result will occur to those of skill in the art.

It will be noted that in the illustration, the guard member comprises a set of elongated recesses from said dispensing protrusions. In at least one alternative example of the invention, the guard member 220 comprises a set of polygonal shapes (e.g., triangles, rectangles, squares, hexagons, etc.). In some such examples some dispensing protrusions reside in the same recess. In other examples, each dispensing protrusion resides in an individual recess, while, in still further examples, all dispensing protrusions are guarded in a single recess. Multiple variations and combinations are available in still further examples that will occur to those of skill in the art.

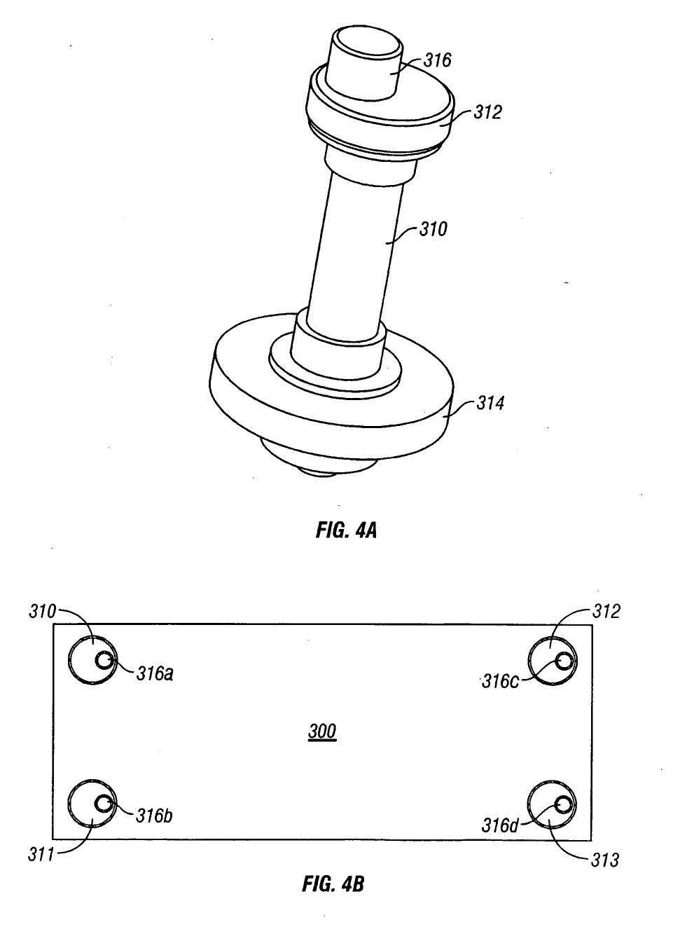

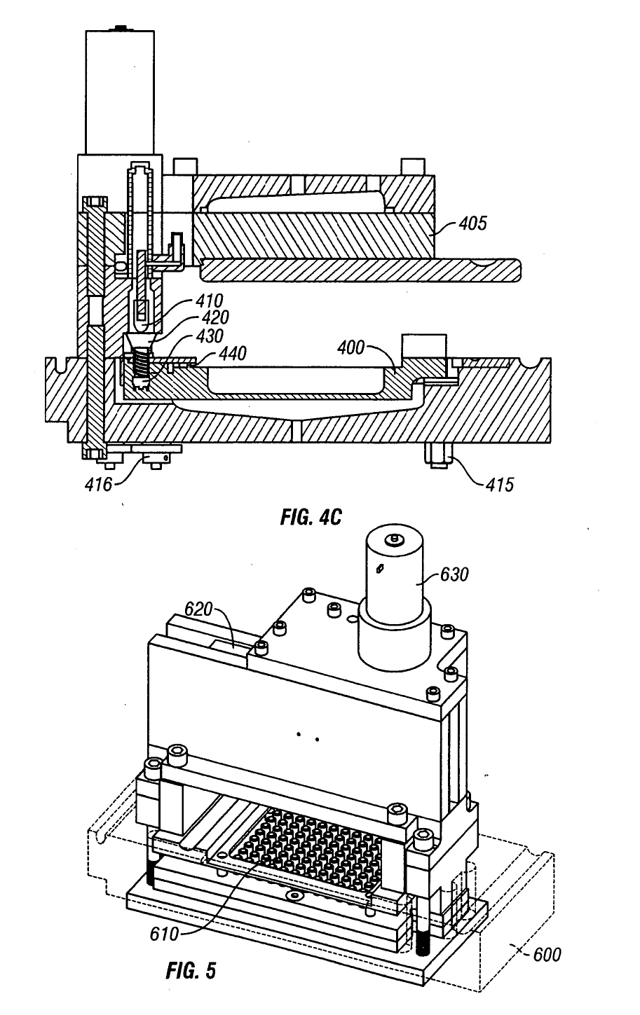

Referring now to FIG. 4, an illustration of a processing plate agitator or “shaker” that is useful according to some examples of the present invention is seen in which agitator plate 300, which is moveable with respect to the processing station, sits upon eccentric bolts 310-313. At least one eccentric bolt 310 is in rotational contact with shaker motor 320 such that when motor 320 is operating, eccentric bolt 310 rotates causing the rotational force to be transmitted to agitator plate 300. In an alternative embodiment, at least two eccentric bolts are in rotational contact with shaker motor 320. In still a further embodiment, at least three eccentric bolts are in rotational contact with shaker motor 320. In one example embodiment, eccentric bolt 310 contacts shaker motor 320 via gears, not shown, attached to shaker motor shaft 350. In one embodiment of the present invention illustrated by FIG. 4a, a detail of eccentric bolt 310 is shown where eccentric bolt 310 is in contact with agitator plate 300 (FIG. 4), not shown, via shaft 316. Gears 314 are located at the base of the eccentric bolt. As shown in the illustration, shaft 316 is located offset from the center of rotation of eccentric bolt 310. Such an arrangement causes “agitation” along shaker plate 300 while eccentric bolt 310 rotates. According to some examples of the present invention, seen in FIG. 4b in a bottom cut away view, shaker plate 300 comprises eccentric bolts 310-313, and shafts 316a-316d. Other location of shafts 316a-316d with respect to each are used in other examples of the invention. In the illustrated example, as well in at least some others, all four shafts rotate around the centers of rotations of their respective eccentric bolts 310-313. Referring still to FIG. 4, eccentric bolts 311-313 rotate in concert with bolt 310, when bolt 310 is rotating, due to the mechanical forces imparted on bolts 311-313 from the interaction between eccentric bolt 310 and shaker plate 300. The motion of agitator plate 300, in some embodiments of the present invention, is in two dimensions along the plane defined by the top of agitator plate 300. In other alternative embodiments of the present invention, the motion of agitator plate 300 is in three dimensions with respect to the plane defined by the top of agitator plate 300.

In at least some examples of the invention, when a processing plate, not shown, is located on the shaker plate 300, the processing plate is aligned with the dispensing protrusions, not shown, from fluid dispenser 340 so that fluid is delivered to the processing plate wells without spillage. In some example embodiments of the invention, this alignment is achieved via a shaker plate alignment device 360. Referring now to FIG. 4c, one possible embodiment of a shaker plate alignment device for aligning shaker plate 400 below fluid dispenser 405 is shown. Shaker plate 400 is attached to the illustrated processing station via at least eccentric bolts 415 and 416. During operation, in several embodiments of the present invention, alignment cone 410 is lowered into the rough alignment cone 420, which is, in some embodiments, attached to and rides with shaker plate 400 during agitation. The interaction between rough alignment cone 420 and alignment cone 410 causes shaker plate 400 to be pulled or pushed into the direction of the center of alignment cone 410. In some embodiments of the present invention, after rough alignment is accomplished via rough alignment guide 420 alignment cone 410 is extended further into alignment shaft 430 until the shaker plate 400 is aligned with the fluid dispenser 405 such that when a processing plate, not shown, is placed on shaker plate 400, fluid can be delivered through fluid dispenser 405, to the processing plate wells, without spillage.

In some examples of the current invention, a processing plate is secured to the shaker plate to prevent the processing plate from being shaken off the shaker plate during agitation. In one such example, gripper 440, identified as 370 in FIG. 4, is used under a spring force securing a processing plate to shaker plate 400.

In some example embodiments, gripper 440 is pulled away from the base of a given processing plate, not shown, when alignment cone 410 is lowered into rough alignment cone 420.

During operation, in one example embodiment, prior to delivery of a processing plate to shaker plate 400, alignment cone 410 is seated at the base of alignment shaft 430, aligning shaker plate 400 with fluid dispenser 405 and retracting gripper 440. A processing plate, not shown, is then delivered to shaker plate 400. To begin agitation, alignment cone 410 is raised, releasing shaker plate 400, allowing gripper 440 to grip the processing plate to hold it on shaker plate 400, and eccentric bolt 416 is rotated.

Referring now to FIG. 5, in some example embodiments of the present invention, apertures in the sample wells of a given processing plate are created by a piercer. In at least one example embodiment of the present invention, a station 600 having a piercer array 610 also includes ram 620 and ram actuator 630. During operation, a given processing plate is located above piercer array 610 such that each individual piercer in piercer array 610 is located substantially centered with and below each individual processing well to be pierced in said processing plate, not shown. In one example embodiment, ram 620 is lowered onto the processing plate by actuator 630, pressing the plate onto the piercer array 610 causing the piercer to create an aperture in the samples wells of the given processing plate. In one example embodiment, when ram 620 is raised, the given processing plate “pops” up into position to be transferred to the next processing station due to stored energy from a spring force stored in the processing plate skirt during piercing due to the interaction between the skirt and the walls surrounding piercer array 610. In an alternative embodiment, said pop up motion is achieved by a mechanism designed to lift a given processing plate off the piercer array where said mechanism would be obvious to those with skill in the art. In yet another example embodiment of the present invention, ram 620 comprises an assembly that surrounds the top and partially surrounds the base of a given processing plate, capturing the plate by its skirt, leaving an opening below the plate so piercers in the piercer array 610 may enter the bottom of the plate when ram assembly 620 is lowered over the array 610. During operation, in some example embodiments, ram assembly 620 accurately locates a given processing plate above piercers 610 and moves with the plate as it travels down to the piercers and back up after piercing. When ram 620 is raised, the given processing plate is lifted off of the piercer array and away from the aperture creating elements 610, which in the present invention are needles. In further examples the aperture creating elements 610 are blades, heated rods, a laser and/or other suitable device as will occur to those of skill in the art. In many example embodiments of the present invention, the size of the apertures in the wells after piercing is large enough to allow fluid and other material to be pulled through the aperture when a pressure differential is created between the open end of a well and the aperture end of a well but small enough to keep fluid and other material from “leaking” out the apertures during transfer between processing stations. In other example embodiments, the size of the apertures allows leakage during transfer between processing stations. In some embodiment, the contamination barrier, described above, in a given processing plate, keeps surfaces from contacting processing plate wells during transfer between processing stations to prevent leakage from processing plate well apertures and to prevent contaminants from contacting fluid and other material present at the apertures during processing. In at least one alternative embodiment, the piercer array 610 is raised to create the apertures in the processing wells while a given processing plate is held stationary.

Referring now to FIG. 5A, in at least one example of the invention, a cross section of FIG. 5 is shown. Ram 620 is lowered by actuator 630 through the use of a worm gear assembly 640 that is in contact with ram 620 via an eccentric bolt arrangement 650. During operation, in at least one example of the invention, worm gear assembly 640 rotates, causing ram 620 to lower a given processing plate onto piercer array 610. In a further example, actuator 630 comprises a piston arrangement, leaver arrangement, and/or other screw arrangement, or any arrangement, known to those with skill in the art, for raising and lowering ram 620. In some examples, actuator 630 is attached directly to ram 620 rather than attached at an offset to a worm screw assembly as illustrated in FIG. 5A.

Referring now to FIGS. 5B and 5C, in at least one example embodiment of the invention, a cross section is shown of a given processing plate 660 located at a piercing station 658, said plate having skirt 670, and processing wells 662, 664, and 668. FIG. 5B illustrates the arrangement of piercers 672, 674, and 676 inside piercer guards 678, 679, and 680, located below processing wells 662, 664, and 668 and processing well guards 663, 665, and 667 prior to plate 660 being lowered onto the piercer array. Referring now to FIG. 5C, processing wells 662, 664, and 668 are shown after piercers 672, 674, and 676 have created “holes” or “apertures” in the bottom of the processing wells 669, 671, and 673.

FIG. 5D shows one alternative embodiment of a piercing guard design where the guard comprises a piercer 675, an outer guard tube 690, a spring 692, and an inner guard tube 694. During operation, in one alternative embodiment, a given processing well is lowered onto outer guard tube 690, causing 690 to act against spring 692 and slide down and around inner guard 694, exposing piercer 675. After piercing, the spring force stored in spring 692 lifts the processing well and thus the processing plate, not shown, off the piercer.

Referring now to FIGS. 5E and 5F, in an alternative example embodiment of the invention, a cross section is shown of a given processing plate located at a piercing station, not shown, said plate having processing wells 662, 664, and 668. FIG. 5E illustrates the arrangement of piercers 672, 674, and 676 inside piercer guards 678, 679, and 680, located below processing wells 662, 664, and 668 prior to the processing plate being lowered onto the piercer array. Referring now to FIG. 5F, processing wells 662, 664, and 668 are shown after piercers 672, 674, and 676 have created “holes” or “apertures” in the bottom of the processing wells 669, 671, and 673.

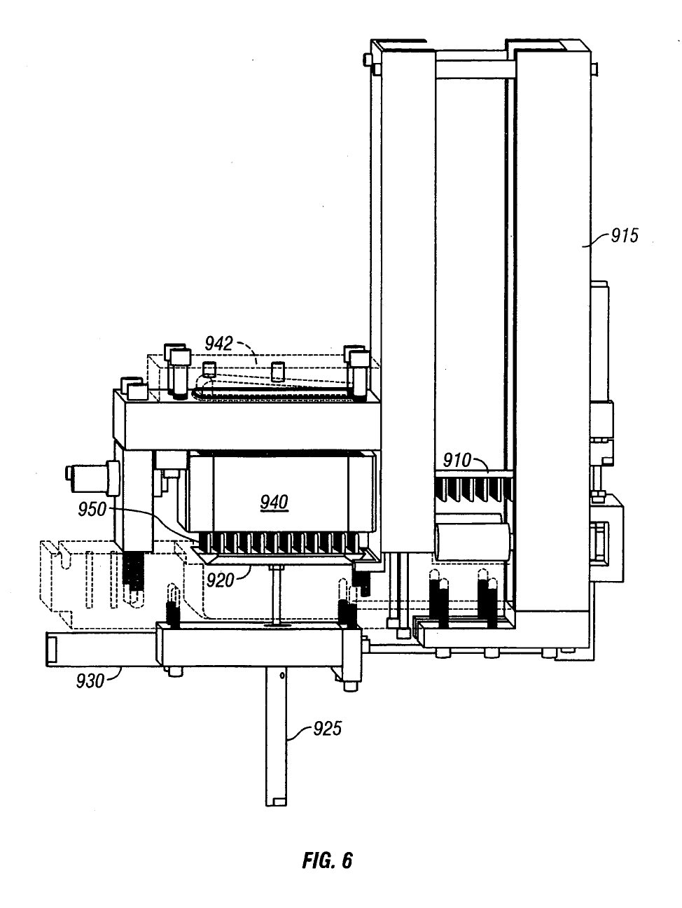

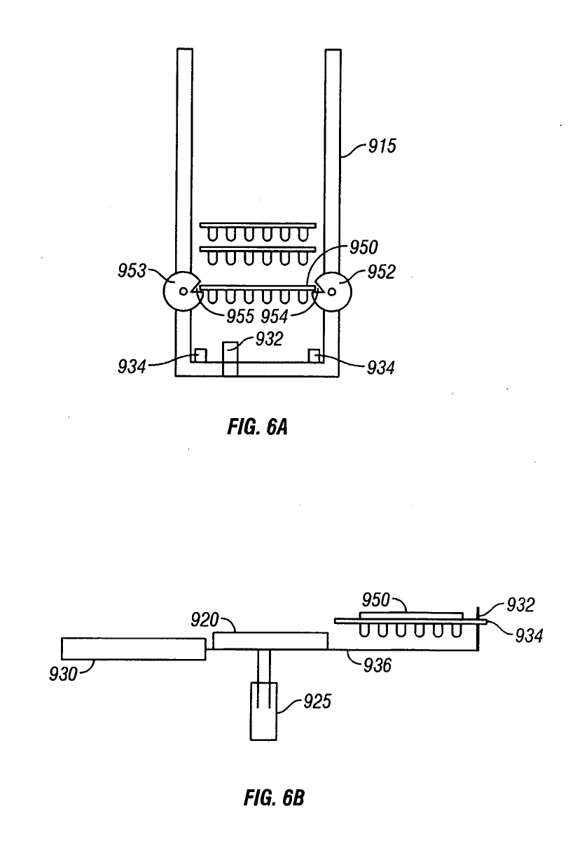

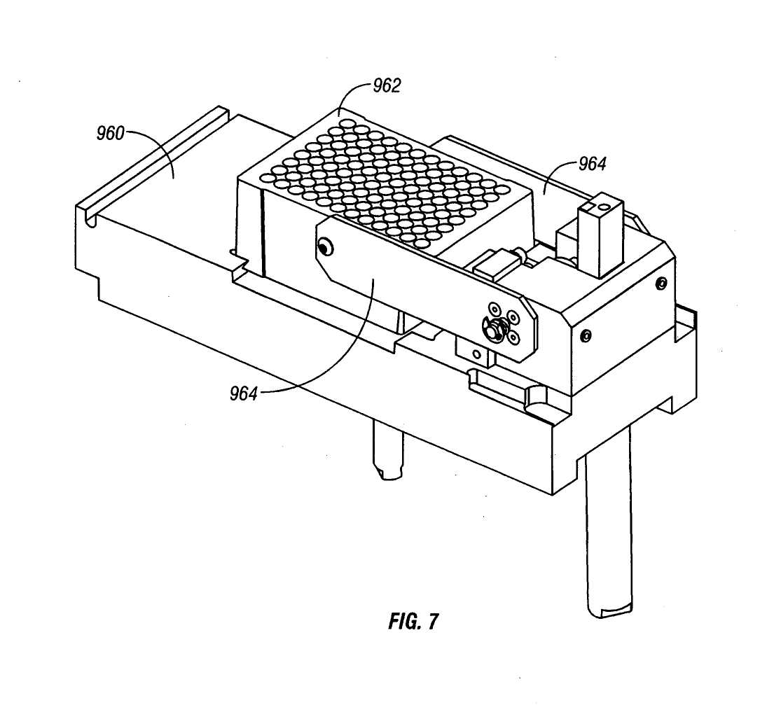

Referring now to FIG. 6, a collector plate dispenser that is useful according to some examples of the present invention is seen in which collector plates 910, also known as “microtiter” plates, are stacked in dispenser 915, ready for delivery to horizontal slider 930. In a variety of example embodiments, horizontal slider 930 pulls or pushes collector plates 910 onto piston shelf 920; and, in some examples, piston shelf 920 is raised and lowered by piston 925 such that the collector plate is aligned and brought into contact with the processing wells, not shown, on processing plate 940. In the illustrated example, microtiter plate 950 is shown aligned and in contact with the processing wells on processing plate 940. In some examples, processing plate 940 is, in turn, aligned with fluid dispenser 942 positioned for accurate processing as described above.

During operation, in at least one example, FIG. 6A illustrates a microtiter plate 950 held in dispenser 915 by rollers 952 and 953 inside roller notches 954 and 955. Microtiter plate 950 is dispensed when roller 952 rotates in a counter clockwise direction and at the same time roller 953 rotates in a clockwise direction, each roller rotating at substantially the same rotational speed in relation to each other. Notches 954 and 955 “capture” the microtiter plate 950 and deposit it onto rails 934 and “in front of horizontal slider capture arm 932. In this manner, rollers 952 and 953 keep any microtiter plates positioned above 950 in the dispenser 915. To deposit a next microtiter plate, rollers 952 and 953 rotate back “up” into position to capture a next microtiter plate.

In at least some examples of the invention, dispensing micro titer plates is performed with the same mechanism illustrated by FIG. 2 above and processing plates are delivered using the same mechanism as illustrated by FIG. 6A.

FIG. 6B illustrates further examples of the invention in which the collector or “microliter” plate 950 is seen resting or “riding” along rails 934. Slideable actuator 930 comprises a piston 936 and a horizontal slider capture 932 positioned and arranged such that during operation, actuator 930 contacts microtiter plate 950, pushing it along rails 934 onto piston shelf 920, where the microtiter plate 950 is positioned for accurate insertion into the processing wells of a given processing plate, not shown. In still further example embodiments, rails 934 are eliminated and microtiter plate 950 is guided by the interior walls and floor of the dispenser and/or any arrangement, known to those with skill in the art, that serve to guide the microtiter plate onto the piston shelf 920.

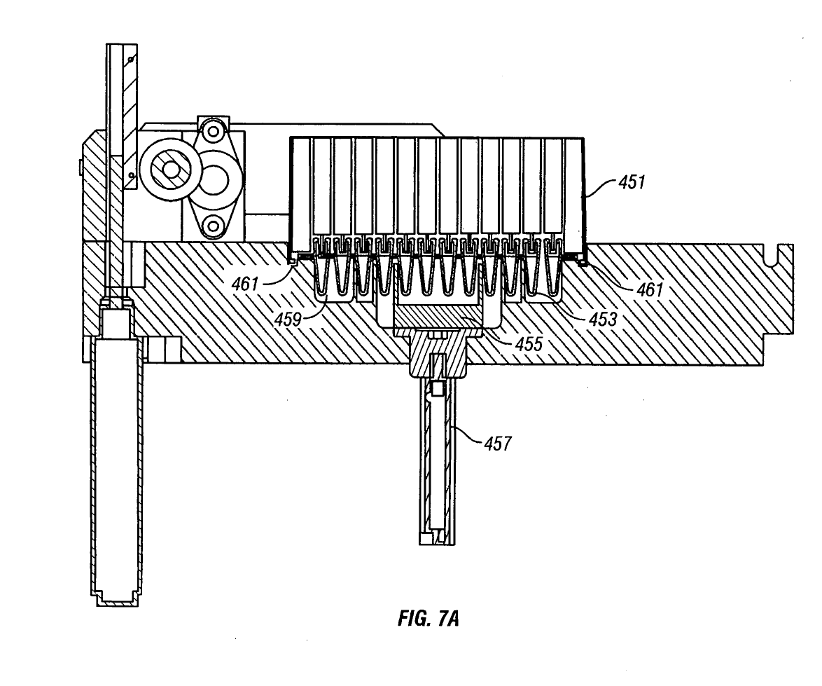

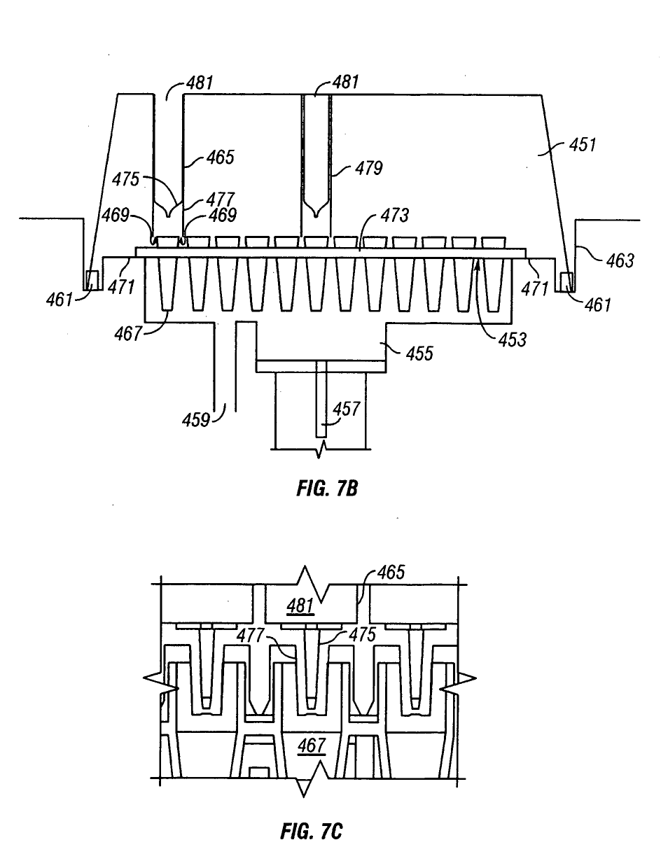

Referring now to FIG. 7, an elute station 960 that is useful according to some examples of the present invention is seen in which processing plate 962 is positioned above a pressure aperture and seal, not shown, allowing a reduction in pressure through the pressure aperture to draw fluid and other material through apertures in sample wells of plate 962 and deposit or “elute” the fluid and material into collection wells in a given microtiter plate that has been aligned below plate 962, the microtiter plate (not shown). Processing container removal arms 964 are shown in contact with plate 962 such that after elute, in some embodiments of the present invention, the processing container is removed from above a given microtiter plate (not shown). The microtiter plate is then used for further processing.

Referring now to FIG. 7A, a cross-section is shown of an elute station with processing plate 451 and collection plate 453 positioned for processing over a pressure aperture 459, elevator shelf 455, and actuator 457. In at least one example, a pressure aperture 459 includes a seal 461 for interaction with a sealing surface on the skirt of plate 451. Referring now to FIG. 7B, in at least one embodiment, the interaction of the skirt sealing surface on plate 451 and seal 461 allows a reduction in pressure through pressure aperture 459 to draw fluid and other material through at least one aperture 475 in the sample well 481 of plate 451 and deposit the fluid and other material into at least one collection well 467 of collection plate 453, while at the same time allowing air to escape through gap 469.

In some embodiments of the present invention, microtiter plates consist of 96 collection wells arrayed and held in relation to each other by plate 473. In some example embodiments, collection wells comprise a cylindrical body having an open end and a spherical closed end. In other embodiments, plate 473 and collection wells are made from a single part. In another example embodiment, the collection wells and plate 473 are made of a thermoplastic material. In other embodiments, any suitable material and any suitable collection well shape that will occur to those of ordinary skill in the art is used. To allow efficient collection during operation in some example embodiments, the collection plate well array is matched to the well array in a given processing plate such that when a given microtiter plate is aligned below a given processing plate, processing plate wells and collection plate wells align such that any fluid or other materials exiting processing well apertures is collected by the collection wells.

During operation, as illustrated in FIG. 7B, in at least one embodiment of the present invention, collection plate 453 and processing plate 451 are transferred to elute station 960 (FIG. 7) by at least one transfer means described herein. Elevator shelf 455 is in a “raised” position and collection plate 453 and processing plate 451 are supported above the elute station by elevator shelf 455. In at least one embodiment, elevator shelf 455 is lowered by actuator 457. Processing plate 451 and collection plate 453 lower with elevator shelf 455 where processing plate 451 is lowered onto seal 461, and collection plate 453 is lowered onto shelf 471. In this arrangement, in at least one embodiment of the present invention, an air gap 469 is maintained between at least collection plate well 481 and processing plate well 467. In some example embodiments, after elute is complete, processing plate 451 is removed by removal arms 964 (seen in FIG. 7), elevator shelf 455 is raised, raising collection plate 453 for further processing. In other example embodiments, processing plate 451 is removed after elevator shelf 455 is raised.

In at least one alternative embodiment of the present invention, illustrated in FIG. 7C, the interaction of the skirt sealing surface on the processing plate and seal, not shown, allows a reduction in pressure through a pressure aperture to draw fluid and other material through at least one aperture 475 in the sample well 481 of the processing plate and deposit the fluid and other material into at least one collection well 467 of a collection plate, while at the same time allowing air to escape through air gaps between collection well 467 and guard 477. The example configuration above provides a barrier between sample wells and collection wells. An advantage of this configuration is to prevent cross-contamination.

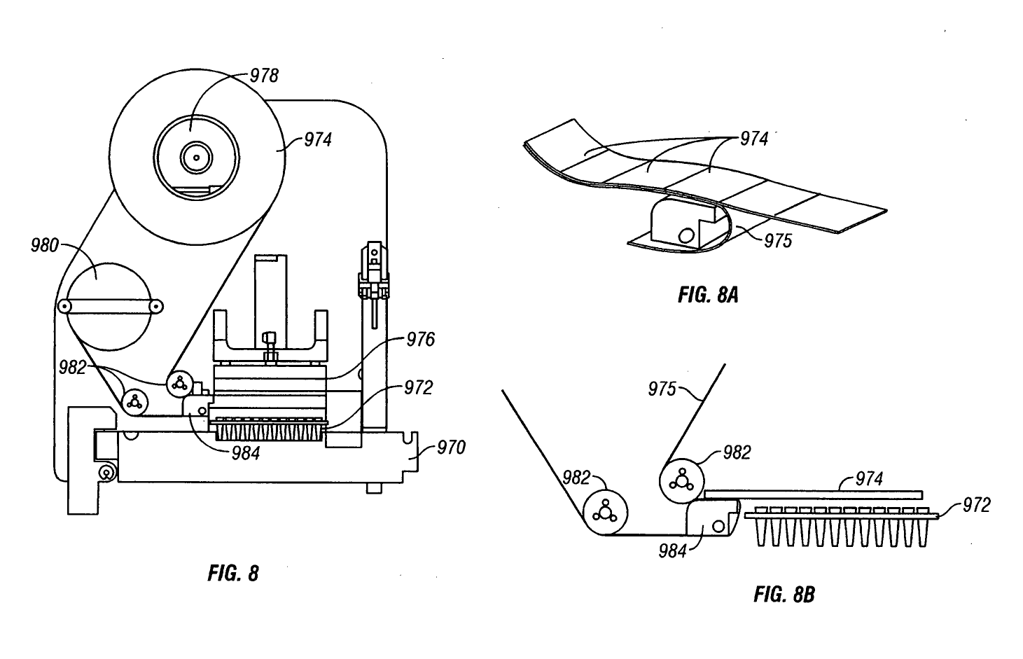

Referring now to FIG. 8, a collector plate sealer that is useful according to some examples of the present invention is seen in which microtiter plate 972 is sealed using sealing film 974 in conjunction with press head 976. During operation, in some examples of the present invention, sealing film 974 is held on a transfer media that is wound around wheel 978. In one example of the present invention, illustrated in FIG. 8A, pre-sized sealing films 974 are held on carrier sheet 975. When carrier sheet 975 is bent around separator 984, sealing film 974 releases from the carrier sheet 975. As more carrier sheet 975 is pulled across separator 984, more of film 974 is released until the entire length of sealing film 974 is released from the carrier sheet; the sealing film is then deposited across the face of press 976 and above a microtiter plate, not shown. In at least some embodiments the face of press 976 comprises small holes through which air is drawn to aid in guiding film 974 while being positioned above a collection plate. In still further examples, rollers, rails and/or any other suitable means, known to those with skill in the art, that serve to guide film 974 while being positioned over a plate are used. In still further embodiments, no guiding is used at all; the rigidity of film 974 serves to guide itself during positioning above the plate.

FIG. 8B shows a close up sectional view of sealing film 974, partially released from carrier sheet 975 and above plate 972 upon which it is deposited after film 974 has been fully released from carrier sheet 975.

Looking again at FIG. 8, tensioning wheels 982 align carrier sheet 975 and sealing film 974 along separator 984 in such a fashion as to cause sealing film 974 to release from carrier sheet 975. In some embodiments, carrier sheet 975 is wrapped around spindle 980 as the carrier sheet is used up. During operation, in some embodiments, after delivery of sealing film 974 to plate 972, press 976 contacts sealing film 974, pressing it onto the top of and causing a seal to be formed between the sealing film 974 and the plate 972. In at least one embodiment of the present invention, sealing film 974 seals to plate 972 using an adhesive that will not contaminate the biological samples held in plate 972. In some other embodiments, sealing film 974 is sealed to plate 972 via a heating element, not shown, located in press 976, such that film 974 adheres to the top of plate 972. Other adhering techniques will occur to those with skill in the art.

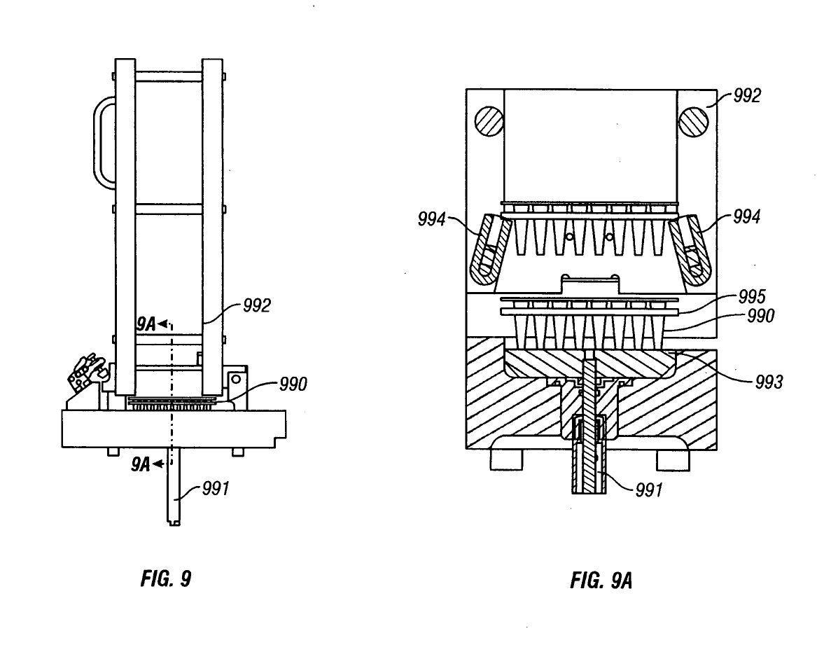

Referring now to FIG. 9, a stacker that is useful according to some examples of the present invention is seen in which sealed microtiter plates are stacked for later retrieval. In the illustrated example, sealed microtiter plate 990 is positioned above elevator 991 just prior to insertion into stacker 992. In some embodiments of the present invention, plate 990 is positioned using at least one transfer means describe herein. Referring now to FIG. 9A, in some embodiments of the present invention, a section view of collection plate stacker 992 is shown. During operation, in one example embodiment of the present invention, plate 990 sits on top of elevator shelf 993. Upon actuation, elevator 991 lifts elevator shelf 993 and 990 such that plate 990 is brought into contact with retention bars 994. As plate 990 continues to rise and press against retention bars 994, the bars rotate away from plate 990 allowing it to rise past the bars 994 and simultaneously lift any microtiter plates already located upon bars 994 and above plate 990. After microtiter plate lip 995 passes bars 994, bars 994 rotate back into their original position, holding all microtiter plates above bars 994 in the stacker 992. In some example embodiments of the present invention, bars 994 return to their closed position via springs, not shown. In other example embodiments, bars 994 are actuated by an actuator, not shown, to rotate to an open position where a given microtiter plate is “stacked” above the bars and then returns to their closed in manners and using techniques that are well understood in the art.

In a further description of the examples seen in FIGS. 1-10B, a system is illustrated for treatment of a plurality of biological samples in a multi-sample container. In the illustrated example, the system comprises a means for moving a first multi-sample container to a first processing station, a means for processing the first multi-sample container at the first processing station, a means for moving the first multi-sample container to a second processing station, a means for moving a second multi-sample container to the first processing station, a means for processing the first multi-sample container at the second processing station, and a means for processing the second multi-sample container at the first processing station. In at least one example, a means is provided for moving the first container during at least a portion of the moving of the second container.

Referring again to FIG. 1B, in at least one example, the means for moving a first multi-sample container to a first processing station comprises a slideable actuator 9 in which actuator 9 comprises a shaft 12 with push rods 15 and 17 positioned and arranged between the processing stations 2a and 2b and used as a means for moving processing plate 3 from one station 2 to another. Actuator 15 contacts container 3, pushing it over stops 510 and 512 at station 2a along guides, not shown, up ramps 506 and 518 to station 2b, where stops 514 and 516 and ramps 506 and 518 position container 3 for accurate processing.

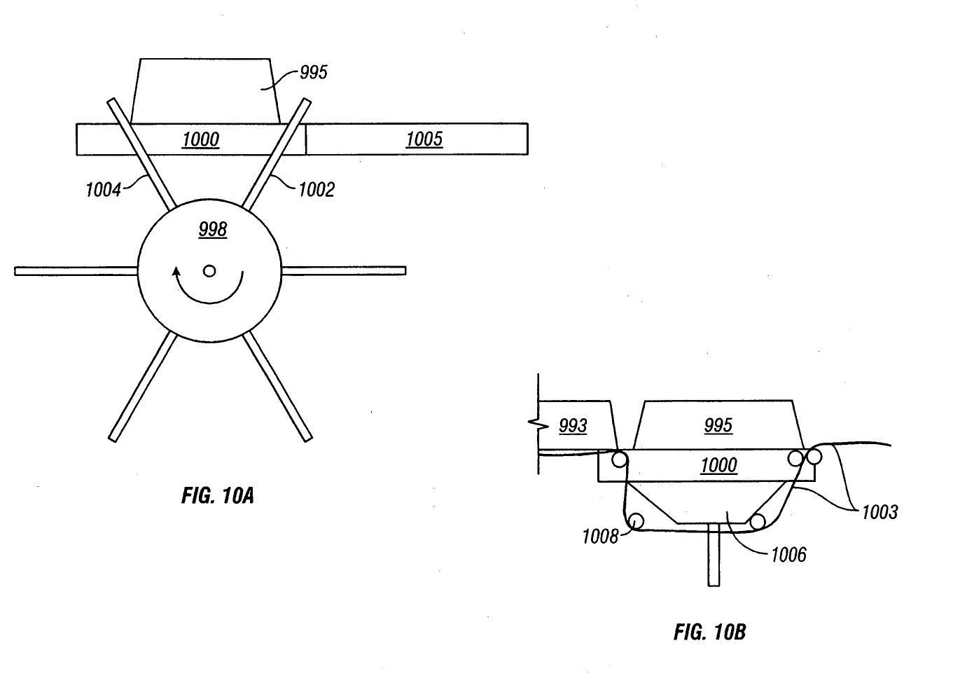

In a further example, the means for moving comprises a rotating wheel 998 with at least one push rod 1002, as illustrated by FIG. 10A. Processing plate 995 is transferred from processing station 1000 to 1005 when wheel 998 rotates in a clockwise direction, in the illustrated example, bringing push rod 1004 into contact with plate 995 causing it to move to station 1005.

In yet another example, the means for moving comprises a conveyor belt, as illustrated by FIG. 10B, where conveyor belt 1003 carriers plate 993 between processing stations, pushing plate 995 onto conveyor 1003 such that plate 995 is transferred to the next processing station and plate 993 is transferred to station 1000. In one example embodiment, the conveyor belt is routed around pressure aperture 1006 via conveyor spindles, for example spindle 1008, so the conveyor does not block plate 995 from contact with pressure aperture 1006.

In at least one example, the means for moving the first multi-sample container is operated during at least a portion of the moving of the second multi-sample container; in a further example, the means for processing the first multi-sample container at the second processing station occurs during at least a portion of the processing of the second multi-sample container at the first processing station.

In a further example of the system illustrated in FIG. 4, the means for processing the first multi-sample container at the first processing station comprises means for contacting a processing fluid with the biological samples in the first multi-sample container. In some such examples, the means for contacting comprises a dispense station 340 that includes means for injecting the processing fluid into the first multi-sample container. In at least one more specific example, the means for injecting 210 comprises conduits, as illustrated by FIG. 3, that operate as injectors that maintain a substantially laminar stream. In the illustrated example, the injectors are substantially cylindrical.

Such an arrangement provides for accurate placement of the processing fluid in the well in which the biological sample resides without the need to insert the injector in the well. This is in contrast to some previous methods of dispensing biological sample fluids into processing wells, in which pipettes or other systems were used with disposable tips. Due to concern that the tips are contaminated during insertion into the well, the tips are discarded after each dispensing step, leading to a disposal problem of potentially hazardous biological waste. Other shapes and stream characteristics will occur to those of skill in the art.

In at least one example of the invention, as seen in FIG. 3, a means for isolating injectors 210 is provided (in the illustration, a recess 220 in a dispensing head 200).

Referring now to FIG. 3 a means for controlling relative amounts of processing fluid dispensed into each of the biological samples is also seen. In the illustrated example, the controlling means comprises a means for supplying processing fluid to multiple injection conduits from a reservoir that is proximate to the dispensing conduits. The reservoir's location with regard to the conduits provides an equalization of pressure and flow, so that the amount of fluid dispensed to each sample will be substantially the same. As seen in FIG. 3B, a further example embodiment for the means for controlling comprises a means for supplying the processing fluid to the proximate reservoir 230 (in the illustrated case, the means for supplying comprises a supply conduit 212, that is attached to a processing fluid supply container 214). In at least one example fluid from supply container 214 is fed to the reservoir by pressurizing supply container 214 and controlling flow by a pinch valve 216 acting on pliable supply tubing 212. In further embodiments gravity-feed or any other suitable means for moving the fluid may be used in place of pressurizing the container. In a still further example, a peristaltic pump, not shown, is used. The benefit of each example is to avoid contact of corrosive or contaminating processing fluid with pump mechanisms. In another example, a pump designed to contact corrosive processing fluids is used. In yet another example, the supply conduit comprises metal tubing and a pump designed to contact corrosive processing fluids. In yet another example, all parts in contact with the corrosive processing fluids in a pump designed to contact corrosive processing fluids are made from a suitable non-corrosive, non-contaminating material such as plastic and/or stainless steel.

Referring now to FIG. 4, in at least one example, the means for processing the first multi-sample container, not shown, at the first processing station comprises means for agitating the first multi-sample container. In some examples, the means for agitating comprises a so-called “shaker” or “vortexer” 300 used to shake the container in which the biological samples reside. Various forms of agitators will occur to those of skill in the art that are used according to various examples of the invention to mix materials in the sample wells of a sample container.

Referring now to FIG. 5, in still a further example, the means of processing the first multi-sample container at the first processing station comprises means for creating an aperture for at least one sample in the first multi-sample container. In some examples of the invention, an aperture is created in each well of the multi-sample container; in other examples of the invention, an aperture is created in less than all of the wells of the container.

In at least one, more specific example of the invention, seen in FIGS. 5B and 5C, the means for creating an aperture comprises means for piercing the multi-sample container in which piercing tips 672, 674, and 676 are mounted on elongate members, not shown, that are recessed in piercing guard members 678, 679, and 680. Piercing tips 672, 674, and 676 are aligned by interaction of protrusions 663, 665, and 667 and piercing guard members 678, 679, and 680 to ensure, in the illustrated example, that wells 669, 671, and 673 are pierced in the correct location. In further embodiments, other interactions between the piercing tips and/or guard members and/or other features of the plate, guide the aperture creating means to ensure that the aperture that is created is properly located in the appropriate well. In still other embodiments, flexibility or looseness of fit between components in the piercing means and or plate aid in proper location of the apertures created. In still further embodiments, no interaction between the piercing tips, guard members or other features of the plate or piercing means occurs and location is accomplished by other means as will occur to those with skill in the art.

In still a further example of the invention, seen in FIG. 1C the means for processing comprises means for removing of a fluid through the aperture, and, in at least one example, the means for removing comprises a means for creating a pressure differential between an interior well of the multi-sample container and the aperture, wherein the pressure is greater in the well than at the aperture. In a specific example, the means for creating a pressure differential comprises means for drawing air from the aperture (e.g., a vacuum pump 513 attached to aperture 511, seen in FIG. 1C); in a further example, the means for creating a pressure differential comprises means for pushing air into the well (e.g., a pressure pump connected to a pressure head, not shown, covering wells 523 in container 3).

In still a further example of the invention, the means for moving comprises means for pushing the multi-sample container. In at least one such example, the means for moving comprises a linearly-actuated member comprising a multi-sample container contact member positioned and arranged for pushing the multi-sample container; in another example, the contact member is positioned and arranged for pulling the multi-sample container. In some examples, a slideable surface or means for sliding is a component of the means for moving; in some such examples, the means for sliding comprises a track having means for guiding (e.g., sample guides 521 and 523 in FIG. 1I) the multi-sample container from one station to the another processing station. As also seen in FIG. 1D, in some examples, the track 521 further comprises seals 512 and 516 that provide friction that aids in positioning the multi-sample container at processing stations.

Referring now to FIG. 1J, in some examples a processing station 43 will include a means for sealing the processing location 43 to the multi-sample container 45. In the illustrated example, the means for sealing comprises a silicone rubber ring 47 set in a recess 49 in track 51. Other materials acceptable for sealing include fluorocarbon, Ethylene Propylene (EPR), rubber, Sintered Silicon-Carbide, plastics some examples being polyethylene, polypropylene, polyvinyl chloride, delrin or any other material as would occur to those skilled in the art. It should be noted that by the use of the term “seal” it is not meant that no gas can pass, rather, the function of the seal is to support a pressure differential which does allow gases to cross the seal in some examples of the invention. For example, as seen in FIG. 1C, in at least one such processing station, a pressure change aperture 551, is connected to a vacuum pump 553 and the resulting decrease in pressure between the well and the pressure change aperture causes fluids and other materials to exit the container 3 through the apertures, not shown, in wells 523 in the container 3.

In still a further example of the invention, seen in FIG. 7b a pressure differential is created between the interior of the wells of processing container 451 and collection container 453. Seal 461 seals the interface between plate 451 and the track 463 and helps maintain the reduced pressure in the pressure change aperture 459. The seal and pressure change aperture means can be substantially the same as those means described in this disclosure. Other means for sealing and reducing pressure below processing containers will occur to those of skill in the art.

In at least one example, collection container 453 mates with processing container 451 in a manner that allows air to flow around collection container members (FIGS. 7A and 7B) as will be explained more fully below.

Referring now to FIG. 7B, an example processing container 451 (sometimes called a “plate”) that is used as a device for biological sample preparation is seen. In the illustrated example, the biological sample preparation device comprises: a plurality of reaction volumes 465 and other volumes not shown, wherein each reaction volume is in a fixed relation to other reaction volumes (Refer to FIG. 1F for one example preparation device), and there is a sample extraction location 475 for each reaction volume 465 and others. As seen in FIG. 7B, in at least one example, a recessed sample extraction location comprises at least one projection 477 beyond each of said recessed sample extraction locations. In the example of FIG. 7B, the recessed sample extraction location comprises at least one projection, not shown, beyond each of said recessed sample extraction locations, similar to the projection 477. In yet another example embodiment, a projection resides between each and around all of said recessed sample extraction locations; in a further example, the at least one projection comprises a single projection around all of said recessed sample extraction locations. In still a further example, the at least one projection comprises multiple projections that, together, define a recess in which there resides each of the recessed sample extraction locations. In a still further example embodiment, at least some of the sample extraction locations are essentially in the same plane as the projection. In still a further example embodiment at least some of the sample extraction locations extend beyond the projections. In still a further example embodiment at least some of the sample extraction locations are recessed relative to the skirt 520 as shown in FIG. 1G. An advantage of having the sample extraction locations recessed relative to the skirt is to prevent contamination of the sample extraction locations during transfer and handling.

In still a further example, the at least one projection resides around at least one of each of said recessed sample extraction locations; and, in still another example, the projection resides around only one of said recessed sample extraction locations.

In still a further example, there are multiple projections wherein each of the multiple projections resides around at least one of said recessed sample extraction locations. In another example, each of the multiple projections resides around only one of each of said recessed sample extraction locations.

In FIG. 7B, an example is seen in which a projection or collar 479 resides around each of said recessed sample extraction locations.

The cross-sectional shape of the elongate members forming recesses varies in a number of examples. A non-exclusive list of acceptable shapes comprises: curved (including cylindrical) and polygonal (including triangles, rectangles, squares, pentagons, hexagons, etc.) some of which are shown in FIG. 1F.

As seen in the illustrated example in FIG. 7B, the reaction volumes comprise an open end 481; in some alternative embodiments, end 481 is closed and/or closeable. The reaction volume for each sample in the illustration also comprises an elongate member; other shapes are used in some alternative examples. Further, in some examples, the reaction volumes are held apart by spacers, while, in still further examples (e.g., FIG. 1F), a substantially unitary structure defines the plurality of reaction volumes and recessed sample extraction locations, not shown, for each reaction volume.

In many example embodiments, the reaction volume comprises an openable, centrifugal member in which a substance is centrifuged in some examples, and opened by various means in further examples. As mentioned before, in at least one such example, the reaction volume is openable to provide a sample extraction location by piercing. In some such examples, there is a piercable material (e.g., plastic), and in some more specific examples, piercable material is re-sealing, while, in others, it is not re-sealing. Some further examples include the use of a break-away member (e.g., a hinged flap), a soluble material, a meltable material, a cap, and/or a photo-reactive material.

In many embodiments, at least one of the plurality of reaction volumes includes retaining material such as silica. As mentioned elsewhere, the growth of biological materials in the presence of retaining material has a benefit of removing a processing step from some methods of processing biological materials. There are further benefits, also. In some instances, the retaining material comprises diatomaceous earth; in further examples, the retaining material comprises silicon dioxide; in further examples, the retaining material comprises glass beads; in further examples, the retaining material is a material that comprises chromatographic media; in still further examples, the retaining material comprises a glass filter. Other forms of silica or binding material useful in various examples of the invention will occur to those of skill in the art.

In some further examples, growth media resides in at least one of the plurality of reaction volumes. Various growth media are useful, depending on a variety of factors. A non-exclusive list of useful growth media includes 2xYT, TB (Terrific Broth), LB (Luria-Bertani) and others for the culture of eukaryotic and/or prokaryotic cells such as bacterial, mammalian, plant and other cell types as will occur to those of skill in the art.

A further explanation of the example of FIGS. 1-10B is that a system for producing a plurality of samples (e.g., polynucleotides) from at least one colony of host cells (e.g., bacteria) is seen in which, the system comprises: means for maintaining a reaction volume for each sample, means for maintaining a distance between the reaction volumes, means for receiving the plurality of samples in the reaction volumes, and means for providing a sample extraction path from each reaction volume.

In some examples (e.g. FIGS. 1-10B) various means are seen for providing at least one recess of at least one sample extraction path. FIG. 1G shows an example in which at least one recess of at least one sample extraction path comprises at least one projection 540 beyond the means 531 for providing at least one sample extraction path.

As shown in FIG. 1G, the projection resides between a plurality of means 531, 532, and 533 for providing a sample extraction path, while, in other embodiments the projection resides around a plurality of means for providing a sample extraction path. In another example embodiment, the projection resides around all of the means for providing a sample extraction path. In another example embodiment, on the other hand, the projection comprises a single projection around all of the means for providing a sample extraction path.

In still another example (e.g., FIG. 7B), multiple projections 481, together, define a recess in which there resides plurality of means for providing a sample extraction path.

In another explanation of various examples, in FIG. 7B, a projection 479 resides around at least one of the means for providing a sample extraction path, while, in another example, the projection resides around only one of the means for providing a sample extraction path. In some examples, multiple projections reside around at least one of the means for providing a sample extraction path; while, in other examples (e.g., FIG. 1F), a skirt 520 is around all the means for providing a sample extraction path from each reaction volume.

In the illustrated example in FIG. 7B, the projection 465 comprises an elongate member having a cylindrical cross-section. In other examples, the elongate member comprises a polygonal cross-section.

Also in the illustrated example, the means for maintaining a reaction volume for each sample comprises an elongate member 465. In some such examples, the reaction volume includes a cross-sectional area having a curved shape, while, in further examples, the elongate reaction volume has a polygonal cross-section.

In a further example, the means for receiving the plurality of samples in the reaction volumes comprises an open end 475 of the reaction volume.

In an alternative description of the example of FIG. 1F, the means for maintaining a distance between the reaction volumes 531-537 comprises spacer members, not shown, between a plurality of the reaction volumes. In FIG. 1F, the means for maintaining a reaction volume for each sample and the means for maintaining a distance between the reaction volumes comprise a substantially unitary structure 500 defining spaced reaction volumes 531-539, and others illustrated but not numbered, in the substantially unitary structure 500. The means for providing a sample extraction path 531, as illustrated in FIG. 1G, from each reaction volume 540 comprises an openable, end member 530.

In a further description of an example of the invention as seen in FIGS. 1-10B, a system is provided for manipulation of multi-sample biological sample containers 3 as illustrated in FIG. 1. In the illustration, the system comprises: means for receiving a first sample container, illustrated by FIGS. 2 and 2A, at a first processing location 2a, means for guiding the first sample container to a second processing location as illustrated in FIGS. 1A-1E, means for holding the first sample container at the second processing location, and means for receiving a second sample container at the first processing location as illustrated by FIGS. 2 and 2A. In an alternative embodiment, means for receiving a first and a second sample container at the first processing location is illustrated by FIGS. 6-6B. In another alternative embodiment, means for guiding the first sample container to a second processing location is illustrated by FIG. 10A and in an alternative example by another means illustrated by FIG. 10B.

Some examples of the invention also include means for pushing the multi-sample container between the first and the second processing locations (e.g. an actuator), in the illustrated example in FIG. 1A, a linear-motion actuator 9 comprising an elongate member slideably connected between the first and the second processing stations wherein the elongate member includes a protrusion residing between the first and the second processing stations.

The actuator of FIGS. 1B and 1E in some examples, comprises a means for pulling or a means for pushing the multi-sample container between the first and the second processing locations. For example, in FIG. 1B, an elongate member slideably connected between the first and the second processing stations wherein the elongate member includes a protrusion residing between the first and the second processing stations. The illustrated example in FIG. 1A, shows a means 9 for sliding the multi-sample container between the first and the second processing locations that comprises a grooved track having a recess in the track. In another alternative embodiment, means for pulling or a means for pushing the multi-sample container between the first and the second processing locations is illustrated by FIG. 10A and in an alternative example, another means for pulling or pushing the multi-sample container between the first and the second processing locations is illustrated by FIG. 10B.

In the present description, in some embodiments of the present invention, the means for guiding comprises guides along a track, the means for holding comprise stops in the track, and the means for receiving a second sample container at the first processing location comprise a second recess in the track.

In another description of a further aspect of the invention, a system is provided for dispensing a biological substance process fluid from a dispensing container to multiple samples of biological substances. As seen in FIGS. 3, 3A, and 3B in at least one example, the system comprises means 212 for receiving from the dispensing container a multiple sample amount of biological substance process fluid, wherein the multiple sample amount is sufficient for processing the multiple samples of biological substances, means 230 for accumulating a multiple sample amount of biological substance process fluid, means 250 for dividing the amount into a set of individual sample amounts in a multidimensional array, and means 220 for substantially simultaneously dispensing the set of individual sample amounts to a set of individual samples.

In the example of FIGS. 3, 3A, and 3B, the means for receiving comprises an accumulator of the multiple sample amount proximate a set of individual sample dispense paths, the means for dividing comprises a manifold of individual sample dispense paths from a reservoir, and the means for dispensing comprises means for streaming the set of individual sample amounts to the multiple samples. In some examples, the means for streaming comprises an injector outside a container holding the multiple samples. In the illustrated example, the means for streaming comprises a recessed injector, held substantially stationary during the receiving, dividing, and dispensing.

In at least one example embodiment of the invention, a system and method for harvesting polynucleotides is provided. In one such system and method the combination of an alkaline lysing buffer and gentle agitation to re-suspend are not used. Rather, in this example of the invention, a non-alkaline buffer is used (substantially neutral pH—e.g., in one example embodiment, 5M Guanidine Solution 1% Sarkosyl is composed of the following reagents in the following proportions for every liter of fluid: 590 gm Guanidine isothiocyanate; 25 ml 1M Tris-HCL, pH 8.0; 10 ml 0.5 M EDTA; 50 ml 20% Sarkosyl; to up to 1000 ml ddH₂O; eliminating the need for a neutralization buffer). It has been found that a problem with an alkaline buffer is that it will destroy the DNA if left in too long. It has also been found that using 5M Guanidine Solution 1% Sarkosyl, in certain embodiments of the present invention, allows for resuspending, lysing, and binding in a single step.

After insertion of the non-alkaline lysis buffer into the wells, in the present example of the invention, the wells are agitated/vibrated (sometimes referred to as “vortexed” because in a cylindrical well, a vortex will result) to mix the lysis buffer with the bacteria to increase the speed of reaction with the multiple bacteria and the number of bacteria that are actually lysed. In at least one example of the invention, the agitation is vigorous (e.g., refer to FIG. 4, eccentric shafts 310-313 rotate at between 120 revolutions per minute (rpm) and 1200 rpm, depending on the bacteria being processed). The bacteria tend to clump and agitation breaks the clumps and helps the lysis buffer to contact and interact with the cell wall to break the cell open.

After the cells have been lysed, there is a mixture in which the plasmids and other cell parts are suspended. In the presence of the lysis buffer, the DNA binds to a silicate surface. In some processes, a solution resulting after lysis (including lysis buffer and open cells) is transferred to another chamber having silicate; however it is an improvement provided by at least one example of the invention to grow the bacteria in the presence of silicate. In at least some examples, the bottom of the wells of the plate are pierced and the lysis buffer fluid is pulled out, leaving the DNA bound to the silicate left in the plate. In many instances, the silicate is put in the wells before the growth media and bacteria are inserted. In other example embodiments of the invention a material other than silicate may be substituted for binding the DNA as will occur to those of skill in the art. Some example alternative binding materials include ion exchange resins, silicon carbide and other media suitable for liquid chromatography applications.

Also, in some systems in which there is a transfer of the solution having lysis buffer and open cells from the wells to another chamber, the other chamber includes chaotropic salt and silicate. In at least one example of the invention, chaotropic salt is inserted in the wells with the lysis buffer. Or, said another way, in some examples of the invention, the lysis buffer includes a chaotropic salt, non-chaotropic salt or other binding promoting substance as would occur to one skilled in the art, to help the polynucleotide of interest (e.g., DNA) to bind to the silicate or other binding media. Some example binding promoting substances or agents are: guanidinium thiocyanate; guanidinium hydrochloride; sodium chloride; potassium chloride; sodium perchlorate; potassium iodide; and sodium iodide. Growing the bacteria in the presence of silicate and adding the salt to the well in which the growth and lysing occurs avoids the need to transfer the resulting post-lying solution to another chamber. In at least one example of the invention, a chaotropic salt or other suitable salt or other suitable binding promoting agent, as would be apparent to one skilled in the art, is inserted in the wells with the lysis buffer and the resulting mixture is then transferred to another vessel and contacted with a binding media such as silicate or other suitable material which binds DNA.

In that post-lysing solution, there is still a lot of material, that is not of interest, still left in the wells, even after the piercing and removal of the lysis buffer. To separate the polynucleotides of interest from the other material, a “wash buffer” is added to the well, which will carry away the cell wall and other parts that are not wanted. In at least one example, the wash buffer comprises a solution in which DNA has low solubility, but other items that are not of interest have a high solubility. For example, high-alcohol-content solution will wash away lipids, chaotropic salts, carbohydrates, and other cell debris and non-desirable items, but DNA is poorly soluble in an alcohol solution. One example of a suitable wash buffer is a 50% wash solution with RnaseA composed of the following proportions per 2.5 liters of solution: 100 ml 1M Tris Acetate pH 7.0, 50 ml 2M Sodium Acetate, 5 ml RnaseA, to 2350 ml dH₂O.

In at least one example of the invention, the lysis buffer includes a detergent that aids in solubilization of cell walls (e.g., sarkosyl, Tritron X-100, SDS, Pluronic L61 made by BASF, IGEPAL, and others that will occur to those of skill in the art). However, in some embodiments, when the well is evacuated, and the column of the lysis buffer reaches the bottom of the well, there is air and lysis buffer. A foam is generated that can build upward and contaminate the sample. Therefore, according to still another example of the invention, rather than pulling the lysis buffer out and then putting wash buffer in, the wash buffer is inserted in the well on top of the lysis solution (after agitation, before evacuation of the lysis buffer). In such a manner, air is isolated from the lysis solution in the well, and there is no foam. In addition to the contamination caused by the foam coming back up the lower evacuation area, the silicate contained residual lysis buffer that, in contact with air, would contaminate the DNA bound in the silicate. The wash buffer passing though the silicate, that is holding the DNA, removes the lysis buffer also from the silicate. Therefore, the first time after lysing that air contacts the silicate, there is no residual lysis buffer in contact with the silicate to cause a foam contamination.

In some further examples, the wash buffer also contains an enzyme that will degrade unwanted RNA (bound with the silicate just as the desired DNA). In some such examples, the wash buffer solution is passed through the well again, leaving it in for a period of time to allow it to work on the RNA.

According to still further examples of the invention, a further wash buffer solution that has a higher alcohol than the first wash buffer follows the first wash buffer solution (which, as discussed above, is used twice in some examples). One example of a suitable further wash buffer solution is an “80% wash solution” composed of the following proportions per 1.0 liter of solution: 100 ml 1M Tris Acetate pH 7.0, 50 ml 2M Sodium Acetate, to 850 ml dH₂O. Air is then caused to flow through the resulting “cake” of silica having the DNA bound to it (to dry the alcohol out). That leaves dry silica with DNA bound to it.

In further embodiments, water is added, which rehydrates the DNA into solution from the silicate.

In still further examples of the invention, a collection plate (a so-called “microtiter” plate in some examples) is set under the processing plate that holds the wells. In some further examples, a centrifuge step drives the DNA solution to the collection plate; in other examples, a vacuum method is used in which an interlocking chimney, as seen in FIG. 7B, between at least microtiter plate collection well 467 and processing well protrusion 477 that has an air gap 469 between a nozzle housing in the wells and the walls of the collection well is used, which provides certain benefits and will be explained in more detail, below.

In still a further example of the invention, the collection plate is sealed so that stacking can occur for storage.

In still a further example of the invention, in the collection plate, there is another precipitation step that occurs to further concentrate the DNA. However, it is believed that no such precipitation step is required with the broader examples of the invention; at least with most plasmids, the plasmid DNA is concentrated in the collection plate enough that the further precipitation step is unneeded. Part of the reason for this is the use, in some examples, of a TRIS acetate in the wash buffer. In some example embodiments, the wash buffer is made of between 5% and 25% by volume of TRIS acetate. In other example embodiments, the wash buffer is made of approximately 10% by volume of TRIS acetate. In other example embodiments and at differing wash steps within the process described above, the wash buffer or wash solution is made of between 0.5% and 10% by volume of TRIS acetate. In other example embodiments, the wash buffer is made of approximately 4% by volume of TRIS acetate. That substance conditions the silica for easier DNA release when water contacts the dried silica. A number of salts are considered useful, although chloride salts have been found not to work as well as acetate-containing salts. Acetate-containing salts are predicted to work better than chloride salts.

In another example embodiment of the invention, a system and method for harvesting M13 DNA is provided. M13 bacterial cultures are incubated in at least one processing plate 3 (illustrated in FIG. 1). At least one well 5 in processing plate 3 contains a filter, supernatant fluid, and polyethylene glycol solution (PEG). In at least one embodiment, the PEG is composed of the following reagents in the following proportions: 200 gm PEG (Sigma Cat. #P-2139); 146 gm NaCl; QS to 1000 ml with sterile H2O.

After the incubation, in a further embodiment, the processing plate 3 is vortexed, as described above and illustrated by FIG. 4, to pellet the phage in the closed end of the wells 5. The wells now contain a filter, a supernatant fluid, and pelleted phage. Next, the closed end of the wells are pierced (illustrated in FIG. 5F) to create an aperture, by a blade, needle or any other device capable of creating an aperture. The travel of the blade or needle is limited so that the blade or needle completely penetrates the wall of the wells 5 but does not completely penetrate the filters, not shown, in wells 5. In this example embodiment, the apertures 669, 671, and 673 are sized such that gravity driven leakage occurs at a sufficiently slow rate to allow the reactions in the following operations to occur before the fluid is lost. In some embodiments, the aperture is sized such that the surface tension of the fluid within the aperture is sufficient to prevent leakage through the aperture. A vacuum is then applied, according to various embodiments of the present invention, to the closed end of processing plate 3, while the open end of processing plate 3 is exposed to ambient pressure. The resulting pressure differential across the apertures 669, 671, and 673 forces the supernatant fluid, not shown, to flow through the filter and out of the wells through the aperture.

Next, a second reagent is added to the wells, in the present embodiment this is done to dissociate the phage proteins from the DNA and a volume of approximately 5.2 milliliters is added. An example second reagent is any de-kaotropic salt solution such as a 6.5M sodium per-chlorate solution composed of the following reagents in the following proportions: 456.63 gm Sodium Perchlorate (Sigma Cat. #51401-500G); 5 mls of 1 M tris-HCL (pH 8.0); 100 micro-liters of 0.5 M EDTA (pH 8.0); QS to 500 mls with sterile H2O. Next, a vacuum is again applied to the closed end of the processing plate to remove the Sodium Perchlorate solution. The DNA is now bound to the filters in the wells. Next, a third reagent is added to the tube or vessel, to wash the excess proteins, salts and other debris from the filter-bound DNA. One example of a suitable third reagent is a 75% Ethanol solution composed of the following reagents in the following proportions: 525 ml of 100% Ethanol (200 proof AAPER Alcohol & Chemical Co., DSP-KY 417); 175 ml sterile H2O. Next, a vacuum is applied to remove the ethanol, in a manner similar to the previous steps.

Next, a fourth reagent is added to the wells. One example of a suitable fourth reagent is any substance that comprises a biological suspension buffer and a divalent cation scavenger such as TE buffer. A suitable quantity for the example TE buffer is 45 micro-liters and comprises the following reagents: Tris (hydroxymethyl) aminomethane (TRIS) and ethylenediaminetetraacetic acid (EDTA). Next a vacuum is applied to the closed end of the processing plate to elute the DNA into a sample container, not shown. The pressure differential across the aperture forces the eluted DNA from the filter through the aperture, and into the container, not shown. The purified DNA is ready for further amplification, sequencing, testing, or storage. The processing container is discarded.

Various steps of the example embodiments of the invention involve forcing fluid through the aperture in the processing plate wells under the influence of a pressure differential across the aperture. In various embodiments, vacuum, positive pressure, or any other method that will occur to those of ordinary skill in the art is used in any of these steps to create the necessary pressure differential. In other embodiments, any suitable means that will occur to those of ordinary skill in the art such as inertia or centrifugal force are used to force the fluid to exit the processing plate wells. In still a further embodiment, the elution of substances such as DNA, RNA or other desired substances as will occur to those of ordinary skill in the art is also accomplished by centrifugation.

Some embodiments of the invention relate to any application where a desired substance is sought to be isolated, extract, or otherwise processed from a sample substance, solid, plasma or gas, containing the desired substance and one or more waste substances. In various embodiments, a desired substance is a protein, DNA, RNA, or any other macromolecule or combination thereof that will occur to those of ordinary skill in the art. In some instances, it may not be necessary to pellet the precipitate.

In yet another example embodiment of the invention, a system and method for harvesting bacterial plasmid DNA is provided. In one example embodiment, bacterial cultures are incubated in a least one processing plate. Cells are harvested in the processing plate by centrifugation at 2500 g for 5 minutes. The supernatant is carefully poured off or pipetted out of the processing plate. In at least one other example embodiment cell harvesting by centrifugation or other means is omitted and lysis buffer is added directly to the culture media containing the target cells. In at least one embodiment, 200 uL of a first reagent is added to each well in the processing plate to resuspend and lyse cells. An example first reagent is composed of the following reagents in the following proportions: 295 g Guanidine isothiocyanate; 12.5 ml 1M Tris-HCL, pH 8.0; 5.0 ml 0.5 M EDTA; 25 ml 20% Sarkosyl; to 500 ml dH₂0. The processing plate it vortexed vigorously for one minute. Next, the mixture is incubated at room temperature for 1 minute to allow time for lysis and binding of plasmid DNA. Next, the closed end of the wells are pierced (illustrated in FIG. 5F) to create an aperture, by a blade, needle or any other device capable of creating an aperture. In this example embodiment, the apertures 669, 671, and 673 are sized such that gravity driven leakage occurs at a sufficiently slow rate to allow the reactions in the following operations to occur before the fluid is lost. In some embodiments, the aperture is sized such that the surface tension of the fluid within the aperture is sufficient to prevent leakage through the aperture.

In at least one embodiment, 400 uL of a second reagent is added to each well in the processing plate. An example second reagent is composed of the following reagents in the following proportions: 8.0 ml 1M Tris Acetate pH 7.0, 4.0 ml 2M Sodium Acetate, 200.0 ml IPA, 400.0 ul RnaseA, to 188.0 ml dH₂O. The plate is incubated at room temperature for at least one minute. A vacuum is then applied, according to various embodiments of the present invention, to the closed end of the processing plate 3, while the open end of the processing plate is exposed to ambient pressure. The resulting pressure differential across the apertures 669, 671, and 673 forces the supernatant fluid, not shown, to flow through out of the wells through the aperture.

In various embodiments, 400 uL of the second reagent is again added to each well in the processing plate. The plate is incubated at room temperature for at least two minutes. A vacuum is then applied in a manner similar to the previous steps.

Next, 400 uL of a third reagent is added to each well in the processing plate. An example third reagent is composed of the following reagents in the following proportions: 8.0 ml 1M Tris Acetate pH 7.0, 4.0 ml 2M Sodium Acetate, 320.0 ml IPA, to 68.0 ml dH₂O. Next a vacuum is applied for between 10 and 15 minutes to evacuate the reagents from the wells. In some embodiments, plasmid DNA is eluted to a collection plate by adding 120 uL of molecular grade water to each well, incubating for at least 3 minutes, locating the collection plate under the processing plate, and applying a vacuum to the closed end of the processing plate, while the open end of the processing plate is exposed to ambient pressure. The purified plasmid DNA is collected in the collection plate, according to some embodiments, in manners described elsewhere in this disclosure. In another example embodiment, purified DNA is collected by centrifuging the processing plate and collection plate combination at 2500 rpm for 1 minute.

In another example embodiment of the invention, a system and method for harvesting yeast plasmid DNA is provided. In one example embodiment, yeast cultures are incubated in a least one processing plate. Cells are harvested in the processing plate by centrifugation at 2500 g for at least 5 minutes. The supernatant is carefully poured off or pipetted out of the processing plate. Next, 150 uL of a first reagent is added to each well containing yeast cells in the processing plate. An example first reagent is composed of the following reagents in the following proportions: 200 nL β-mercaptoethanol to 800 uL lytic enzyme. The processing plate is vortexed for five seconds. Next the plate is incubated at 37 degrees centigrade for at least 60 minutes.

In at least one embodiment, 200 uL of a second reagent is added to each well in the processing plate. An example second reagent is composed of the following reagents in the following proportions: 295 g Guanidine isothiocyanate; 12.5 ml 1M Tris-HCL, pH 8.0; 5.0 ml 0.5 M EDTA; 25 ml 20% Sarkosyl; to 500 ml dH₂0. The processing plate it vortexed vigorously for one minute. Next, the mixture is incubated at room temperature for 1 minute to allow time for lysis and binding of plasmid DNA. Next, the closed end of the wells are pierced (illustrated in FIG. 5F) to create an aperture, by a blade, needle or any other device capable of creating an aperture. In this example embodiment, the apertures 669, 671, and 673 are sized such that gravity driven leakage occurs at a sufficiently slow rate to allow the reactions in the following operations to occur before the fluid is lost. In some embodiments, the aperture is sized such that the surface tension of the fluid within the aperture is sufficient to prevent leakage through the aperture.

In at least one embodiment, 400 uL of a third reagent is added to each well in the processing plate. An example third reagent is composed of the following reagents in the following proportions: 8.0 ml 1M Tris Acetate pH 7.0, 4.0 ml 2M Sodium Acetate, 200.0 ml IPA, 400.0 ul RnaseA, to 188.0 ml dH₂O. The plate is incubated at room temperature for at least one minute. A vacuum is then applied, according to various embodiments of the present invention, to the closed end of the processing plate 3, while the open end of the processing plate is exposed to ambient pressure. The resulting pressure differential across the apertures 669, 671, and 673 forces the supernatant fluid, not shown, to flow through out of the wells through the aperture.

In various embodiments, 400 uL of the third reagent is again added to each well in the processing plate. The plate is incubated at room temperature for at least two minutes. A vacuum is then applied in a manner similar to the previous steps.

Next, 400 uL of a fourth reagent is added to each well in the processing plate. An example third reagent is composed of the following reagents in the following proportions: 8.0 ml 1M Tris Acetate pH 7.0, 4.0 ml 2M Sodium Acetate, 320.0 ml IPA, to 68.0 ml dH₂O. Next a vacuum is applied for between 10 and 15 minutes to evacuate the reagents from the wells. In some embodiments, plasmid DNA is eluted to a collection plate by adding 120 uL of molecular grade water to each well, incubating for at least 3 minutes, locating the collection plate under the processing plate, and applying a vacuum to the closed end of the processing plate, while the open end of the processing plate is exposed to ambient pressure. The purified plasmid DNA is collected in the collection plate, according to some embodiments, in manners described elsewhere in this disclosure. In another example embodiment, purified DNA is collected by centrifuging the processing plate and collection plate combination at 2500 rpm for 1 minute.

The present invention provides methods and devices for preparing alternative substances from biological materials. The unique properties of these devices, which are described in detail in this disclosure, enable useful, novel methods for preparing a variety of substances. Specific substances that can be prepared from biological material by practicing the present invention include, but are not limited to: single and double stranded DNA molecules from bacteriophages; bacterial plasmids; fungal plasmids such as yeast plasmids; Bacterial Artificial Chromosomes (BAC's); viral nucleic acids, genomic DNA from a variety of cell types such as genomic DNA from nucleated blood cells; protein molecules; antibody molecules; RNA molecules; carbohydrate molecules; lipid molecules; and cell metabolites.

In addition, the present invention also provides novel methods and devices for processing biochemical samples. These methods and devices are particularly effective for enabling the preparation of biologically or biochemically derived molecules for biochemical manipulation or analysis. Examples of processes in which the methods and devices of the present invention are useful include, but are not limited to: nucleic acid template preparation for biochemical manipulations such as PCR or DNA sequencing; the clean-up of biochemical reaction products, such as DNA thermocycle sequencing products; the clean-up of PCR reaction products for further manipulation and/or analysis; the preparation of biochemically modified or processed protein molecules for further modification or analysis, such as preparation of protein fragments for analysis by MALDI-TOF mass spectrometry; and the preparation of labeled nucleic acid samples, such as cDNA labeled with fluorescent dyes for expression analysis with gene chips or spotted arrays.

A novel aspect of the present invention is the use of container piercing to change a reaction vessel from a vessel open at one point to a vessel with at least two apertures. As a result of the piercing process, the sample preparation vessel can be transformed from a container with certain utilities such as the ability to be used as a culture chamber for cell growth or as a collection vessel for centrifugation, to a modified container with a variety of alternative utilities, such as a filter device, a column for gel filtration or a column for chromatography. This change in functionality can occur without the need to transfer the material being processed from one vessel to another. Thus, this aspect of the invention provides a novel, useful mechanism to carry out a variety of new methods to prepare substances from biological materials and to prepare and purify biochemical samples for manipulation and analysis. It will be further apparent that the novel methods described here for processing samples in a single container will enable multiple processing steps to be combined and performed in parallel within the single container. This ability provides particular efficiency and utility.

The present invention provides methods and devices that fundamentally alter and improve these sample preparation processes in useful ways by allowing multiple, alternative processing steps, which otherwise would require multiple transfer steps to alternative containers, to be performed in a single container.

Specific examples of processes that can be performed in an improved way by employing the present invention, include, but are not limited to the preparation or purification of nucleic acids, proteins and other biologically derived macromolecules. The adaptation of existing methods to the alternative system provided by the present invention can be accomplished without the need for undue experimentation by appropriately configuring and implementing the methods and devices described in detail in this disclosure. To demonstrate the flexibility of the single container system for performing sample processing, several specific examples are provided below. It will be apparent that a variety of alternative methods can be enabled by practicing the present invention.

Deoxyribonucleic Acids. A variety of forms of deoxyribonucleic acid molecules can be isolated from biological materials using methods and devices provided by the present invention. For example, plasmid DNA molecules, bacteriophage M13, yeast plasmids, cosmids, or BAC's can be prepared from cells using the present invention. In a specific embodiment of the present invention, cells are grown in a cell culture block like the devices described herein, the cells being grown in the presence of a nucleic acid binding substrate such as silica particles. They are collected by centrifugation and resuspended in an aqueous buffer containing a chaotropic agent (with appropriate cell wall degrading enzymes being added in advance for organisms such as yeast, as needed) and sufficient salt concentration to allow DNA binding to the substrate. The culture block is then pierced to create filter columns and the binding substrate is washed with an appropriate wash buffer, such as a 50% isopropanol solution. It is desirable to add ribonuclease enzyme to the wash buffer to enzymatically degrade RNA molecules in the sample. This sample is further washed with an 80% isopropanol solution and then the binding substrate is dried such as by vacuum, followed by elution of the nucleic acid with a low salt solution, for example with water, and the nucleic acid is collected in a collection vessel. This can be performed, for example, by vacuum driven elution or by centrifugation.

Genomic DNA from whole blood. The methods and devices of the present invention are also useful to prepare genomic DNA from whole cells such as nucleated blood cells. Such methods are especially useful for genetic analysis, such as genotyping or SNP analysis. Whole blood can be added directly to a container such as described herein where the container has been loaded with an appropriate binding substrate for nucleic acid such as silica particles. The cellular material from the blood can then be collected by centrifugation and the liquid portion decanted away. The pelleted cells can be resuspended in an appropriate buffer for lysis and binding, for example a buffer with a chaotropic salt. The container is then pierced to create a filter column for further processing. The contaminating materials are washed away using appropriate wash buffers, such as appropriate salt containing buffers with 50% isopropanol. The sample is further washed with an 80% isopropanol salt containing buffer, dried, and the genomic DNA is eluted with a low salt elution buffer such as water, then collected, for example by centrifugation or vacuum elution into a collection vessel.

mRNA molecules. The isolation of mRNA molecules from cells is useful to analyze gene expression in a cell, for example by preparing fluorescently labeled cDNA from the mRNA and then hybridizing the cDNA to a DNA microarray. A biological material, such as mammalian cells from which RNA is to be isolated can be added directly to a device such as the 96 well block described herein. The block should also contain an mRNA specific binding matrix, for example an oligo dT containing cellulose resin. The chamber is pierced to create filter columns and washed with appropriate wash buffers to remove contaminants. The RNA is then eluted with an elution buffer such as water and collected in a collection vessel.

Antibody molecules. The manipulation of antibody molecules has been extensively employed to develop useful purification, analytical, and therapeutic processes. Thus detailed methods and protocols for the isolation of functional antibody molecules are well established. Appropriate antibody manipulation protocols can be adapted to use with the methods and devices of the present invention. For example, an antibody containing serum sample from an animal can be processed using the devices of the present invention by collecting the serum in closed block (processing plates) such as described herein, where the chambers of the block containing an appropriate antibody-binding substrate, such as a protein A or protein G containing resin to bind the selected antibody molecules to the substrate. The antibodies can then be further processed by piercing the vessels to create filter columns, rinsing these filter columns with wash buffers, and eluting the antibodies into a collection vessel with appropriate elution buffers.

Protein molecules. The isolation of specific protein molecules generally requires specific methods adapted to the properties of the individual protein to be isolated. This the particular steps to be followed will be chosen for the desired product. In general a biological sample will be prepared, for example by culturing cells in the 96 well culture block described herein. The cells will be collected by centrifugation and media decanted away. Then the cells will be resuspended in an appropriate resuspension, and lysis buffer. The isolation of the protein will proceed following piercing, using appropriate binding or chromatography resins within the chamber. In many cases it will be possible to specifically bind the desired protein using an antibody with specific affinity for the protein of interest. In this case the appropriate antibody would be attached to a suitable solid support using methods well known in the art. Alternatively, by configuring the processing chamber appropriately, for example by layering a chromatography resin on top of an ion exchange binding substrate, several alternative preparation processes can be performed on the protein within a single container.

It will be apparent to those skilled in the art that various other alternative processes can be enabled using the present invention.

While, for the purposes of disclosure there have been shown and described what are considered at present to be example embodiments of the present invention, it will be appreciated by those skilled in the art that other uses may be resorted to and changes may be made to the details of construction, combination of shapes, size or arrangement of the parts, or other characteristics without departing from the spirit and scope of the invention. It is therefore desired that the invention not be limited to these embodiments and it is intended that the appended claims cover all such modifications as fall within this spirit and scope.

What is claimed is:

1. A device for processing containers having a plurality of biological sample wells wherein at least one of the wells includes a biological sample, the device comprising:
at least two processing stations;
a sample guide between the at least two processing stations; and
an actuator of the container from at least one processing station to at least another processing station.

2. A device as in claim 1, wherein at least one of the processing stations comprises a processing plate dispenser.

3. A device as in claim 1, wherein at least one of the processing stations comprises a processing plate agitator.

4. A device as in claim 1, wherein at least one of the processing stations comprises a processing fluid dispenser.

5. A device as in claim 4, wherein said processing fluid dispenser comprises a set of injectors.

6. A device as in claim 5, wherein said injectors are recessed.

7. A device as in claim 5, wherein said injectors are stationary.

8. A device as in claim 4, wherein said processing fluid dispenser comprises:
a reservoir comprising;
a biological substance process input port; and
a plurality of dispense ports, and a set of dispensing protrusions connected to the dispense ports.

9. A device as in claim 1, wherein at least one of the processing stations comprises a processing plate piercer.

10. A device as in claim 1, wherein at least one of the processing stations comprises a pressure aperture.

11. A device as in claim 1, wherein the at least one of the processing stations comprises a seal positioned and arranged for interaction with the container.

12. A device as in claim 1, wherein at least one of the processing stations comprises a collector plate dispenser.

13. A device as in claim 1, wherein at least one of the processing stations comprises a collector plate sealer.

14. A devise as in claim 1, wherein said at least two processing stations comprise at least two multi-sample, biological sample container processing stations and further comprising:
guides between the at least two multi-sample, biological sample container processing stations; and
stops at a plurality of the at least two multi-sample, biological sample container processing stations.

15. A device as in claim 14, wherein at least one processing stations comprises a seal positioned and arranged for contact with a sample container.

16. A device as in claim 15, wherein the least one processing station comprising a seal further comprises a pressure aperture.

17. A device as in claim 14, further comprising a slideable actuator mounted between the at least two processing stations.

18. A system for treatment of a plurality of biological samples in a multi-sample container, the system comprising:
means for moving a first multi-sample container to a first processing station;
means for processing the first multi-sample container at the first processing station;
means for moving the first multi-sample container to a second processing station;
means for moving a second multi-sample container to the first processing station;
means for processing the first multi-sample container at the second processing station; and
means for processing the second multi-sample container at the first processing station.

19. A system as in claim 18, wherein said means for moving the first multi-sample container is operated during at least a portion of the moving the second multi-sample container.

20. A system as in claim 18, wherein said means for processing the first multi-sample container at the second processing station occurs during at least a portion of the processing of the second multi-sample container at the first processing station.

21. A system as in claim 18, wherein said means for processing the first multi-sample container at the first processing station comprises means for contacting a processing fluid with the biological samples in the first multi-sample container.

22. A system as in claim 18, wherein said means for processing the first multi-sample container at the first processing station comprises means for agitating the first multi-sample container.

23. A system as in claim 18, wherein said means of processing the first multi-sample container at the first processing station comprises means for creating an aperture for at least one sample in the first multi-sample container.

24. A system as in claim 23, wherein said means for creating an aperture comprises means for piercing the multi-sample.

25. A system as in claim 24, wherein said means for piercing comprises an elongate member.

26. A system as in claim 23, wherein said means for processing comprises means for removing of a fluid through the aperture.

27. A system as in claim 26, wherein said means for removing comprises means for creating a pressure differential between an interior well of the multi-sample container and the aperture, wherein the pressure is greater in the well than at the aperture.

28. A system as in claim 18, wherein said means for moving comprises means for pushing the multi-sample container.

29. A system as in claim 18, wherein said means for moving comprises a linearly-actuated member comprising a multi-sample container contact member.

30. A system as in claim 18, wherein said means for moving comprises a track having means for guiding the multi-sample container from the first processing station to the second processing station.

31. A system as in claim 30, wherein said track further comprises stops for positioning the multi-sample container at the first processing station and at the second processing station.

32. A system as in claim 18, further comprising:
means for receiving the first multi-sample container, at a first processing location;
means for guiding the first multi-sample container to a second processing location;
means for holding the first multi-sample container at the second processing location; and
means for receiving a second multi-sample container at the first processing location.

33. A device comprising:
at least two multi-sample, biological sample container processing stations;
guides between the at least two multi-sample, biological sample container processing stations; and
stops at a plurality of the at least two multi-sample, biological sample container processing stations.

34. A device as in claim 33, wherein at least one processing stations comprises a seal positioned and arranged for contact with a sample container.

35. A device as in claim 34, wherein the least one processing station comprising a seal further comprises a pressure aperture.

36. A device as in claim 33, further comprising a slideable actuator mounted between the at least two processing stations.

37. A system for manipulation of multi-sample biological sample containers, the system comprising:
means for receiving a first sample container at a first processing location;
means for guiding the first sample container to a second processing location;
means for holding the first sample container at the second processing location; and
means for receiving a second sample container at the first processing location.

38. A system as in claim 37, further comprising means for advancing the multi-sample container between the first and the second processing locations.

39. A system as in claim 38, wherein the means for advancing comprises an actuator.

40. A system as in claim 38, wherein the means for advancing comprises a linear-motion actuator.

41. A system as in claim 40, wherein the linear-motion actuator comprises an elongate member residing between the first and the second processing stations wherein the elongate member includes a protrusion slideably connected between the first and the second processing stations.

42. A system as in claim 37, further comprising means for sliding the multi-sample container between the first and the second processing locations.

43. A system as in claim 42, wherein said means for sliding comprises a grooved track.

44. A system as in claim 37, wherein said means for receiving comprises a first recess in a track.

45. A system as in claim 37, wherein said means for guiding comprises guides along a track.

46. A system as in claim 37, wherein said means for holding comprises stops in the track.

47. A system as in claim 37, wherein said means for receiving a second sample container at the first processing location comprises a second recess in the track.
